(19) United States
(12) Patent Application Publication
(10) Pub. No.: US 2023/0361957 A1
(43) Pub. Date: Nov. 9, 2023

(54) SOUNDING REFERENCE SIGNAL DELAY

(71) Applicant: QUALCOMM Incorporated, San Diego, CA (US)

(72) Inventors: Muhammad Sayed Khairy ABDELGHAFFAR, San Jose, CA (US); Alexandros MANOLAKOS, Escondido, CA (US)

(21) Appl. No.: 18/245,693

(22) PCT Filed: Nov. 9, 2021
(86) PCT No.: PCT/US2021/058637

§ 371 Date: Mar. 16, 2023

(30) Foreign Application Priority Data
Nov. 9, 2020 (GR) 20200100672

(51) Int. Cl. H04L 5/00

(52) U.S. Cl. CPC H04L 5/0048; H04L 5/001; H04L 5/0078; H04L 5/0094

(57) ABSTRACT

Aspects relate to delaying transmission of a sounding reference signal (SRS). A user equipment (UE) may transmit an SRS a certain number of slots after downlink control information (DCI) that triggers the transmission of the SRS. A base station may configure the UE with a set of delay parameters that are mapped to different bit values. The DCI that triggers the transmission of an SRS may include a bit field for indicating one of the delay parameters. A base station may set a bit in the bit field of the DCI to indicate that the UE is to use the corresponding delay parameter for the transmission of the SRS. A UE that receives the DCI may map the value of the DCI bit field to the set of delay parameters to determine the delay parameter to use for the SRS transmission.

### CROSS-REFERENCE TO RELATED APPLICATION(S)

The present application for patent claims priority to and the benefit of pending Greece Patent Application No. 20200100672, titled “SOUNDING REFERENCE SIGNAL DELAY” filed Nov. 9, 2020, and assigned to the assignee hereof and hereby expressly incorporated by reference herein as if fully set forth below in its entirety and for all applicable purposes.

### TECHNICAL FIELD

The technology discussed below relates generally to wireless communication and, more particularly, to delaying the transmission of a sounding reference signal.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) for different UEs operating within a cell of the base station.

A UE may transmit reference signals to enable a base station to estimate a wireless communication channel between the UE and the base station. For example, a UE may generate a sounding reference signal (SRS) based on a known sequence and transmit the SRS on resources allocated by the base station. The base station may then estimate the quality of an uplink channel from the UE based on the SRS and/or determine other information based on the SRS. The base station may use this channel estimate or other information to, for example, more efficiently allocate resources and/or specify transmission parameters for communication over one or more channels.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a method for wireless communication at a user equipment is disclosed. The method may include receiving a plurality of indications specifying a plurality of time occasions relative to a reference slot for transmission of a sounding reference signal (SRS) by the user equipment, and transmitting the SRS at a time that is based on a first indication of the plurality of indications.

In some examples, a user equipment may include a transceiver, a memory, and a processor coupled to the transceiver and the memory. The processor and the memory may be configured to receive via the transceiver a plurality of indications specifying a plurality of time occasions relative to a reference slot for transmission of a sounding reference signal (SRS) by the user equipment, and transmit via the transceiver the SRS at a time that is based on a first indication of the plurality of indications.

In some examples, a user equipment may include means for receiving a plurality of indications specifying a plurality of time occasions relative to a reference slot for transmission of a sounding reference signal (SRS) by the user equipment, and means for transmitting the SRS at a time that is based on a first indication of the plurality of indications.

In some examples, an article of manufacture for use by a user equipment includes a non-transitory computer-readable medium having stored therein instructions executable by one or more processors of the user equipment to receive a plurality of indications specifying a plurality of time occasions relative to a reference slot for transmission of a sounding reference signal (SRS) by the user equipment, and transmit the SRS at a time that is based on a first indication of the plurality of indications.

In some examples, a method for wireless communication at a base station may include transmitting to a user equipment a plurality of indications specifying a plurality of time occasions relative to a reference slot for transmission of a sounding reference signal (SRS) by the user equipment, and receiving the SRS at a time that is based on one of the plurality of indications.

In some examples, a base station may include a transceiver, a memory, and a processor coupled to the transceiver and the memory. The processor and the memory may be configured to transmit via the transceiver to a user equipment a plurality of indications specifying a plurality of time occasions relative to a reference slot for transmission of a sounding reference signal (SRS) by the user equipment, and receive the SRS via the transceiver at a time that is based on one of the plurality of indications.

In some examples, a base station may include means for transmitting to a user equipment a plurality of indications specifying a plurality of time occasions relative to a reference slot for transmission of a sounding reference signal (SRS) by the user equipment, and means for receiving the SRS at a time that is based on one of the plurality of indications.

In some examples, an article of manufacture for use by a base station includes a non-transitory computer-readable medium having stored therein instructions executable by one or more processors of the base station to transmit to a user equipment a plurality of indications specifying a plurality of time occasions relative to a reference slot for transmission of a sounding reference signal (SRS) by the user equipment, and receive the SRS at a time that is based on one of the plurality of indications.

One or more of the following features may be applicable to one or more of the method, the apparatuses, and the computer-readable medium of the preceding paragraphs. The plurality of indications may include a first delay value and a second delay value. The first delay value may include a second indication to a first available slot and the second delay value may include a third indication to a second available slot that is different from the first available slot. The plurality of indications may include a first delay value and an indication to use a first available slot.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an example of wireless resources in an air interface utilizing orthogonal frequency divisional multiplexing (OFDM) according to some aspects.

FIG. 4 is a conceptual illustration of an example of wireless communication via multiple radio frequency (RF) carriers according to some aspects.

FIG. 5 is a signaling diagram illustrating an example of signaling for scheduling a sounding reference signal (SRS) transmission according to some aspects.

FIG. 6 is a diagram illustrating an example of a delay between a downlink control information (DCI) and an SRS transmission according to some aspects.

FIG. 7 is a diagram illustrating examples of SRS transmission issues according to some aspects.

FIG. 8 is a diagram illustrating examples of SRS triggering offsets according to some aspects.

FIG. 9 is a diagram illustrating examples of delay parameter tables according to some aspects.

FIG. 10 is a diagram illustrating other examples of delay parameter tables according to some aspects.

FIG. 11 is a diagram illustrating other examples of delay parameter tables according to some aspects.

FIG. 12 is a diagram illustrating an example of group common DCI signaling according to some aspects.

FIG. 13 is a diagram illustrating an example of different subcarrier spacings according to some aspects.

FIG. 14 is a block diagram illustrating an example of a hardware implementation for a user equipment employing a processing system according to some aspects.

FIG. 15 is a flow chart illustrating an example of a method for obtaining SRS delay information according to some aspects.

FIG. 16 is a flow chart illustrating an example of a method including receiving a DCI according to some aspects.

FIG. 17 is a flow chart illustrating another example of a method including receiving a DCI according to some aspects.

FIG. 18 is a flow chart illustrating an example of a method including receiving a group common DCI according to some aspects.

FIG. 19 is a flow chart illustrating an example of a method including receiving a radio resource control (RRC) message according to some aspects.

FIG. 20 is a flow chart illustrating an example of a method for determining an available uplink slot according to some aspects.

FIG. 21 is a flow chart illustrating an example of a method for mapping slot numbers according to some aspects.

FIG. 22 is a flow chart illustrating an example of a method for identifying a reference slot according to some aspects.

FIG. 23 is a flow chart illustrating an example of a method for determining SRS delay information according to some aspects.

FIG. 24 is a block diagram illustrating an example of a hardware implementation for a base station employing a processing system according to some aspects.

FIG. 25 is a flow chart illustrating an example of a method for providing SRS delay information according to some aspects.

FIG. 26 is a flow chart illustrating an example of a method including transmitting a DCI according to some aspects.

FIG. 27 is a flow chart illustrating another example of a method including transmitting a DCI according to some aspects.

FIG. 28 is a flow chart illustrating an example of a method including transmitting a group common DCI according to some aspects.

FIG. 29 is a flow chart illustrating an example of a method including transmitting a medium access control-control element (MAC-CE) according to some aspects.

FIG. 30 is a flow chart illustrating an example of a method for scheduling an SRS transmission according to some aspects.

FIG. 31 is a flow chart illustrating another example of a method for scheduling an SRS transmission according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc. of varying sizes, shapes, and constitution.

The disclosure relates in some aspects to delaying the transmission of a sounding reference signal (SRS). For example, a UE may transmit an SRS a certain number of slots after the slot that carries a downlink control information (DCI) that triggers the transmission of the SRS.

In some examples, a base station may configure the UE with a set of delay parameters (e.g., delay values) for SRS transmissions. These delay parameters may be mapped to different bit values. For example, a bit value of 0 may correspond to a first delay value and a bit value of 1 may correspond to a second delay value.

In some examples, the DCI that triggers the transmission of an SRS may include a bit field for indicating one of the delay parameters. For example, the base station may determine that a particular delay should be specified for the SRS transmission in an attempt to ensure that the UE will transmit the SRS in a valid uplink slot. As another example, the base station may specify different delays for different SRS transmissions to reduce control signal congestion at the base station. In either case, the base station may set a bit in the bit field of the DCI to indicate that the UE is to use the corresponding delay parameter for the transmission of the scheduled SRS.

A UE that receives the DCI may therefore map the value of the DCI bit field to the set of delay parameters to determine a delay parameter to use for the transmission of the SRS. In this way, the UE can transmit the SRS according to the delay parameter. For example, the UE may transmit the SRS during the next available uplink slot that follows a delay period indicated by the delay parameter.

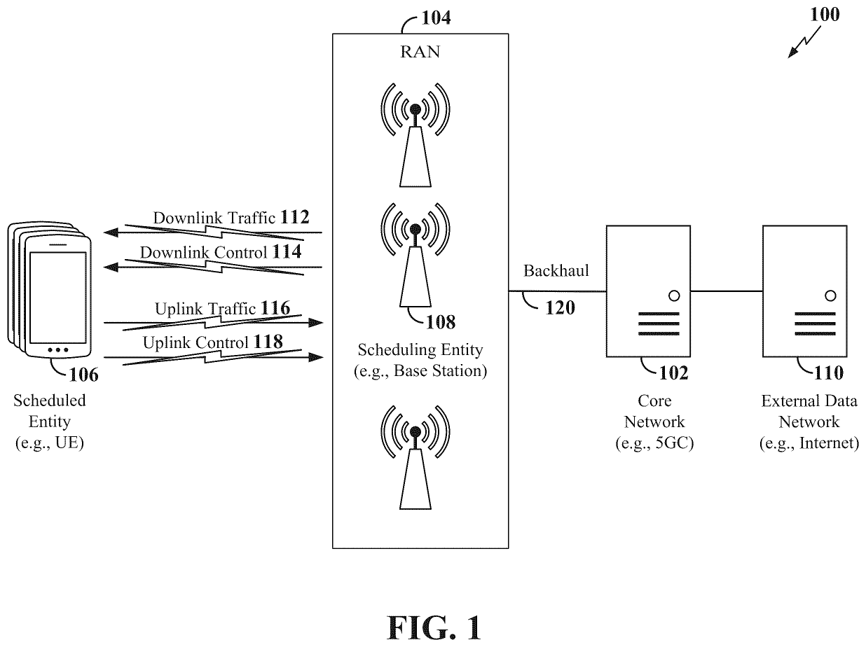

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system 100. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

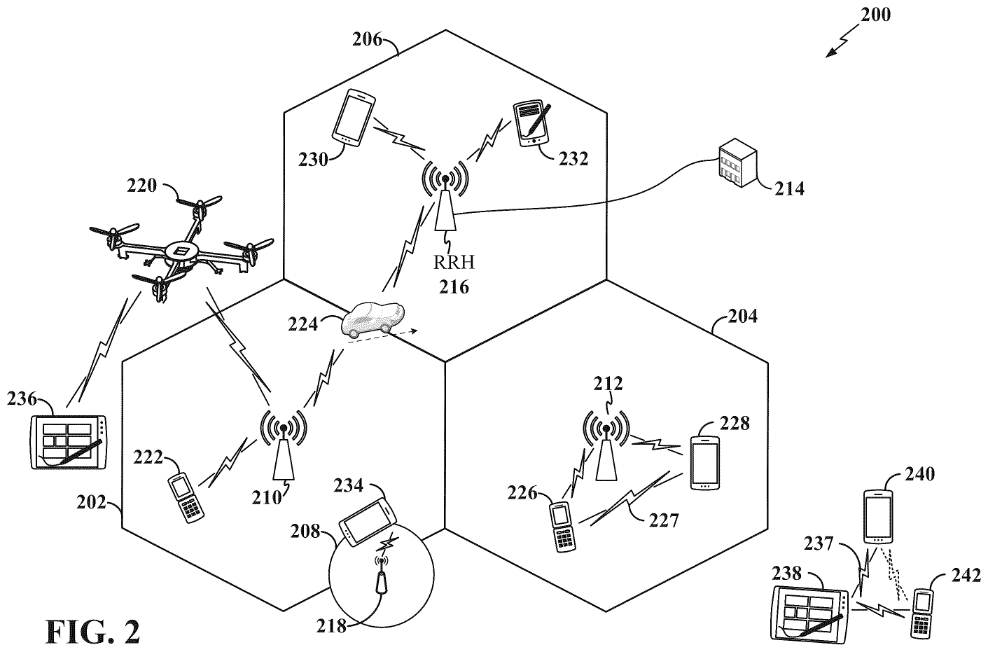

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

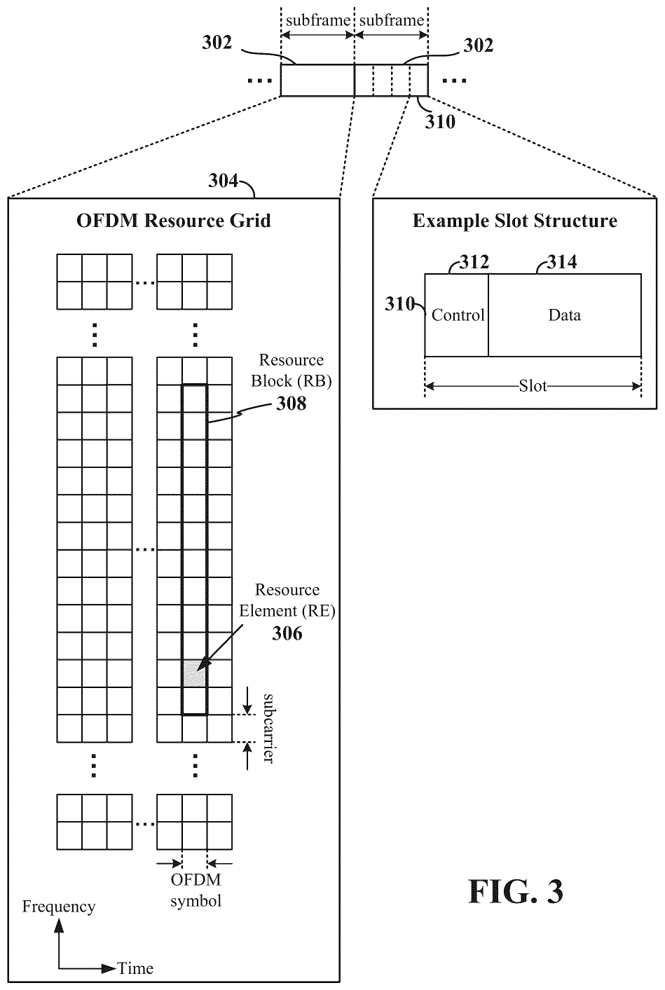

Various aspects of the present disclosure will be described with reference to an OFDM waveform, an example of which is schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example subframe 302 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely an example, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

5G-NR networks may further support carrier aggregation (CA) of component carriers transmitted from different cells and/or different transmission and reception points (TRPs) in a multi-cell transmission environment. The different TRPs may be associated with a single serving cell or multiple serving cells. In some aspects, the term component carrier may refer to a carrier frequency (or band) utilized for communication within a cell.

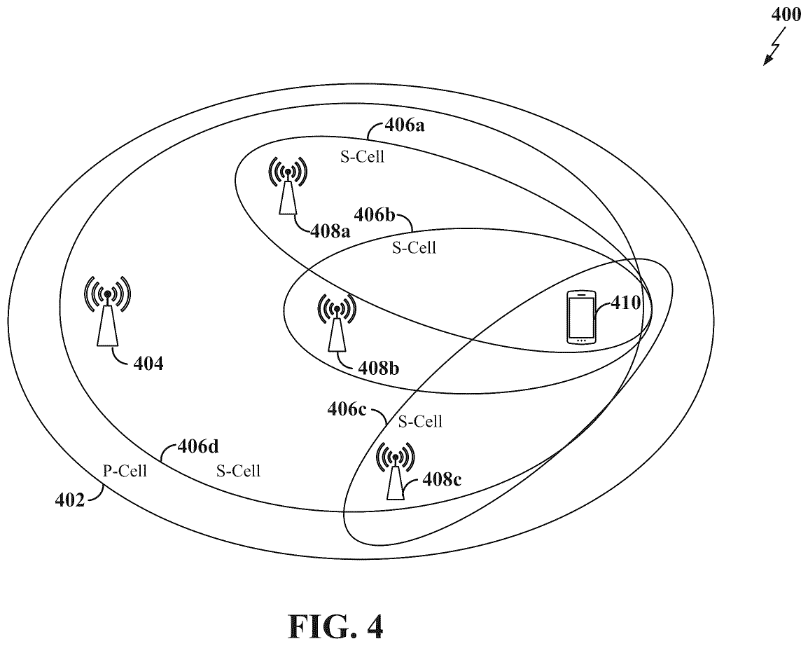

FIG. 4 is a conceptual illustration of a wireless communication system that shows a base station (BS) and a user equipment (UE) communicating via multiple carriers according to some aspects of the disclosure. In particular, FIG. 4 shows an example of a wireless communication system 400 that includes a primary serving cell (PCell) 402 and one or more secondary serving cells (SCells) 406a, 406b, 406c, and 406d. The PCell 402 may be referred to as the anchor cell that provides a radio resource control (RRC) connection to the UE 410. In some examples, the PCell and the SCell may be co-located (e.g., different TRPs at the same location). In some examples, the UE 410 may correspond to any of the UEs or scheduled entities shown in any one or more of FIGS. 1, 2, 5, and 14.

One or more of the SCells 406a-406d may be activated or added to the PCell 402 to form the serving cells serving the UE 410. Each serving cell corresponds to a component carrier (CC). The CC of the PCell 402 may be referred to as a primary CC, and the CC of an SCell 406a-406d may be referred to as a secondary CC. The PCell 402 and one or more of the SCells 406 may be served by a respective base station 404 and 408a-408c or scheduling entity similar to those illustrated in any of FIGS. 1, 2, 5, and 24. In the example shown in FIG. 4, SCells 406a-406c are each served by a respective base station 408a-408c. SCell 406d is co-located with the PCell 402. For example, the base station 404 may include multiple TRPs, each supporting a different carrier. The coverages of the PCell 402 and SCell 406d may differ since component carriers in different frequency bands may experience different path loss.

In some examples, the PCell 402 may add or remove one or more of the SCells 406a-406d to improve reliability of the connection to the UE 410 and/or increase the data rate. The PCell 402 may be changed upon a handover to another PCell.

In some examples, the PCell 402 may utilize a first radio access technology (RAT), such as LTE, while one or more of the SCells 406 may utilize a second RAT, such as 5G-NR. In this example, the multi-cell transmission environment may be referred to as a multi-RAT-dual connectivity (MR-DC) environment. One example of MR-DC is Evolved-Universal Terrestrial Radio Access Network (E-UTRAN)-New Radio (NR) dual connectivity (EN-DC) mode that enables a UE to simultaneously connect to an LTE base station and a NR base station to receive data packets from and send data packets to both the LTE base station and the NR base station.

In some examples, the PCell 402 may be a low band cell, and the SCells 406 may be high band cells. A low band (LB) cell uses a CC in a frequency band lower than that of the high band cells. For example, the high band cells may use millimeter wave (mmW) CC, and the low band cell may use a CC in a band (e.g., sub-6 GHz band) lower than mmW. In general, a cell using a mmW CC can provide greater bandwidth than a cell using a low band CC. In addition, when using a frequency carrier that is above 6 GHz (e.g., mmW), beamforming may be used to transmit and receive signals in some examples.

In some cases, the use of multiple antennas for carrier aggregation or other multiple carrier schemes may be based on the use of one or more antenna ports. An antenna port is a logical entity used to map data streams to antennas. A given antenna port may drive transmissions from one or more antennas (e.g., and resolve signal components received over one or more antennas). Each antenna port may be associated with a reference signal (e.g., which may allow a receiver to distinguish data streams associated with the different antenna ports in a received transmission).

The disclosure relates in some aspects to the scheduling and transmission of a sounding reference signal (SRS). An SRS transmission may involve a UE transmitting SRSs that a base station may use for various purposes including, for example, channel estimation, positioning, codebook generation, and beam selection. For example, a UE may transmit SRSs to a base station over a specified bandwidth to enable the base station to estimate the uplink channel over that bandwidth. In this way, the base station may better schedule uplink transmissions from the UE (e.g., the base station may select the frequency band and transmission parameters the UE is to use for an uplink transmission).

A base station may transmit SRS configuration information to a UE that specifies the SRS resources and other parameters to be used by a UE to transmit SRSs. For example, a base station may configure one or more SRS resource sets for a UE. In some examples, a UE may use different resource sets for transmitting on different symbols. A defined number of antenna ports may be used for each SRS resource. In some examples, a given antenna port may correspond to a particular set of antenna elements and/or other beamforming parameters (e.g., signal phases and/or amplitudes).

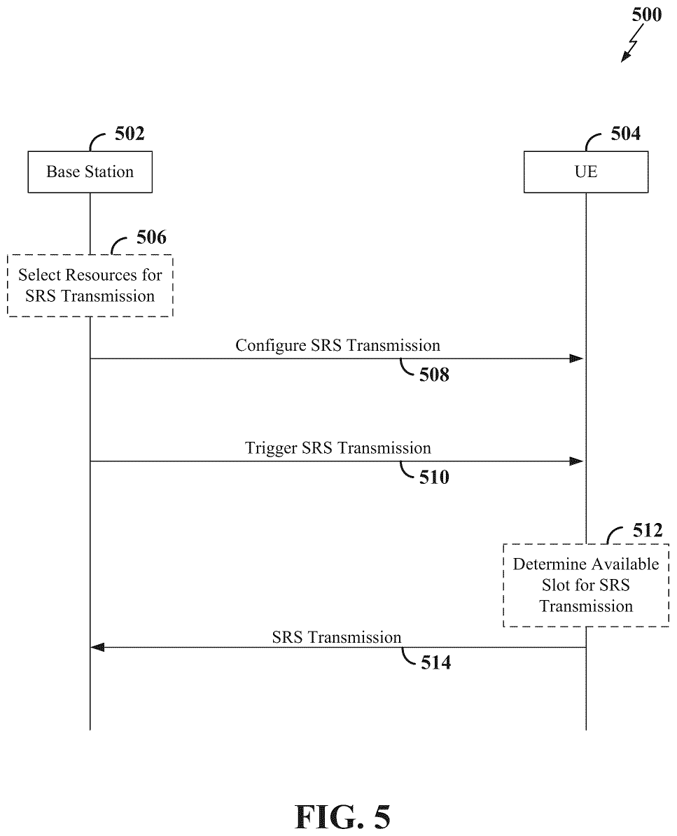

FIG. 5 is a signaling diagram 500 illustrating an example of scheduling an SRS transmission in a wireless communication system including a base station (BS) 502 and a UE 504. In some examples, the BS 502 may correspond to any of the base stations or scheduling entities shown in any of FIGS. 1, 2, 4, and 24. In some examples, the UE 504 may correspond to any of the UEs or scheduled entities shown in any of FIGS. 1, 2, 4, and 14.

At 506 of FIG. 5, the BS 502 selects resources for an SRS transmission. For example, the BS 502 may allocate resources for different SRS resource sets under different BWPs under different cells.

At 508, the BS 502 configures the SRS transmission. For example, the BS 502 may send an RRC message to the UE 504, where the RRC message specifies the resources and other information to be used by the UE 504 for the SRS transmission.

At 510, the BS 502 may trigger the SRS transmission. For example, the BS 502 may send a DCI to the UE 504 on a PDCCH, where the DCI indicates that the UE 504 is to commence an aperiodic SRS transmission.

At 512, the UE 504 determines whether there is an available slot for the SRS transmission.

At 514, the UE 504 transmits the SRS transmission on the scheduled SRS resource set.

In some examples, triggering an aperiodic SRS (A-SRS) transmission may be achieved through the use of 2 bits in a DL or UL DCI. Here, each A-SRS resource set may be tagged with either a 1, or a 2, or a 3. Thus, 2 bits can be used to indicate which SRS resource is triggered. Table 1 illustrates an example of an SRS request with a 2 bit request field.

TABLE 1
SRS request

| | Triggered aperiodic SRS | |
|---|---|---|
| | resource set(s) for DCI format | |
| Value | 0_1, 1_1 and 2_3 configured | Triggered aperiodic SRS resource |
| of SRS | with higher layer parameter | set(s) for DCI format 2_3 configured |
| request | srs-TPC-PDCCH-Group set to | with higher layer parameter srs- |
| field | ‘typeB’ | TPC-PDCCH-Group set to ‘typeA’ |
| 00 | No periodic SRS resource set | No periodic SRS resource set triggered |
| | triggered | |
| 01 | SRS resource set(s) configured | SRS resource set(s) configured with |
| | with higher layer parameter | higher layer parameter usage in SRS- |
| | aperiodicSRS-Resource Trigger | ResourceSet set to ‘antennaSwitching’ |
| | set to 1 or an entry in | and resourceType in SRS-ResourceSet |
| | aperiodicSRS- | set to ‘aperiodic’ for a 1st set of |
| | ResourceTriggerList set to 1 | serving cells configured by higher |
| | | layers |
| 10 | SRS resource set(s) configured | SRS resource set(s) configured with |
| | with higher layer parameter | higher layer parameter usage in SRS- |
| | aperiodicSRS-Resource Trigger | ResourceSet set to ‘antennaSwitching’ |
| | set to 2 or an entry in | and resourceType in SRS-ResourceSet |
| | aperiodicSRS- | set to ‘aperiodic’ for a 2nd set of |
| | ResourceTriggerList set to 2 | serving cells configured by higher |
| | | layers |
| 11 | SRS resource set(s) configured | SRS resource set(s) configured with |
| | with higher layer parameter | higher layer parameter usage in SRS- |
| | aperiodicSRS-Resource Trigger | ResourceSet set to ‘antennaSwitching’ |
| | set to 3 or an entry in | and resourceType in SRS-ResourceSet |
| | aperiodicSRS- | set to ‘aperiodic’ for a 3rd set of |
| | ResourceTriggerList set to 3 | serving cells configured by higher |
| | | layers |

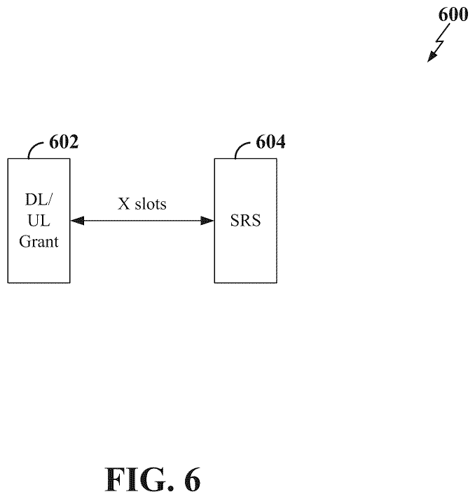

Each A-SRS resource set may be configured by an RRC configuration with a “slotOffset” from 0 . . . 32. Referring to FIG. 6, the parameter slotOffset is an offset (X slots in the example of FIG. 6) in the number of slots between the triggering DCI slot 602 and the actual transmission slot 604 of this SRS resource set. If the offset field is absent, the UE applies no offset (value 0).

Each SRS resource of an SRS resource set has an associated symbol index of the first symbol containing the SRS resource (“startPosition”). This index indicates where the corresponding SRS resource starts within the slot (e.g., the slot 604). An SRS resource may span multiple consecutive OFDM symbols.

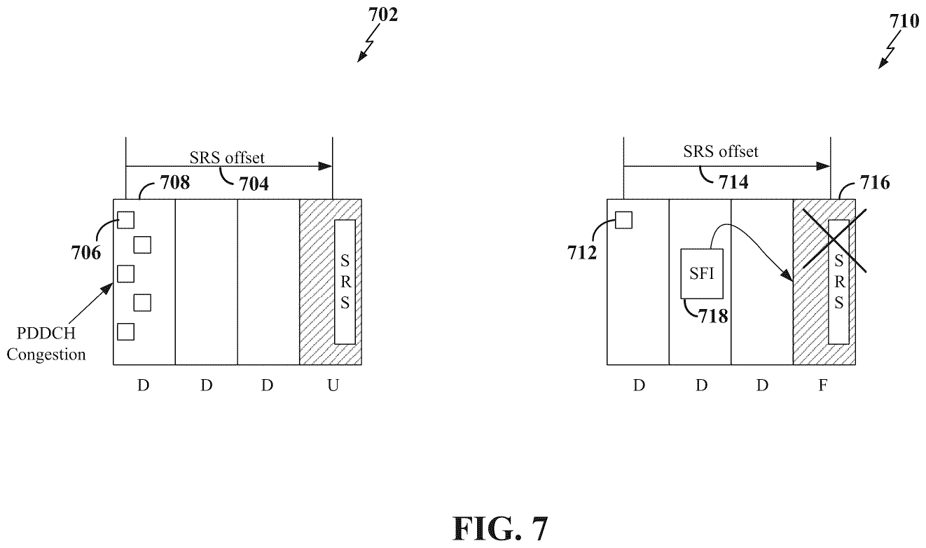

The disclosure relates in some aspects to enhanced flexibility for SRS triggering. In the current NR framework, an A-SRS triggered by an UL/DL DCI at slot (n) is to be transmitted at slot (n+k) where k is the slot offset (e.g., indicated by higher level RRC parameters). This approach limits the PDCCH scheduling flexibility as the network will send the PDCCH carrying the UL/DL DCI at a fixed slot. An example for multi-user SRS triggering is shown in the diagram 702 of FIG. 7. Due to the fixed slot offset 704 between the SRS and the triggering DCI (e.g., DCI 706), there may be PDCCH congestion due to the network needing to send multiple PDCCHs at a specific slot 708. Another example explaining a limitation of the current framework is shown in the diagram 710 of FIG. 7 where a DCI 712 schedules an SRS transmission according to an SRS offset 714 in a previously designated flexible (F) slot 716 that has subsequently been redesignated as a DL slot by a slot format indicator (SFI) 718 and thereby prevents the UE from transmitting the SRS. In a further example, there may be a collision between a scheduled SRS transmission and a higher priority signal/channel where the UE will drop the SRS and transmit the higher priority signal/channel. In some aspects of this disclosure, the SRS can be transmitted later than the scheduled slot in the event resources are not available for the SRS transmission.

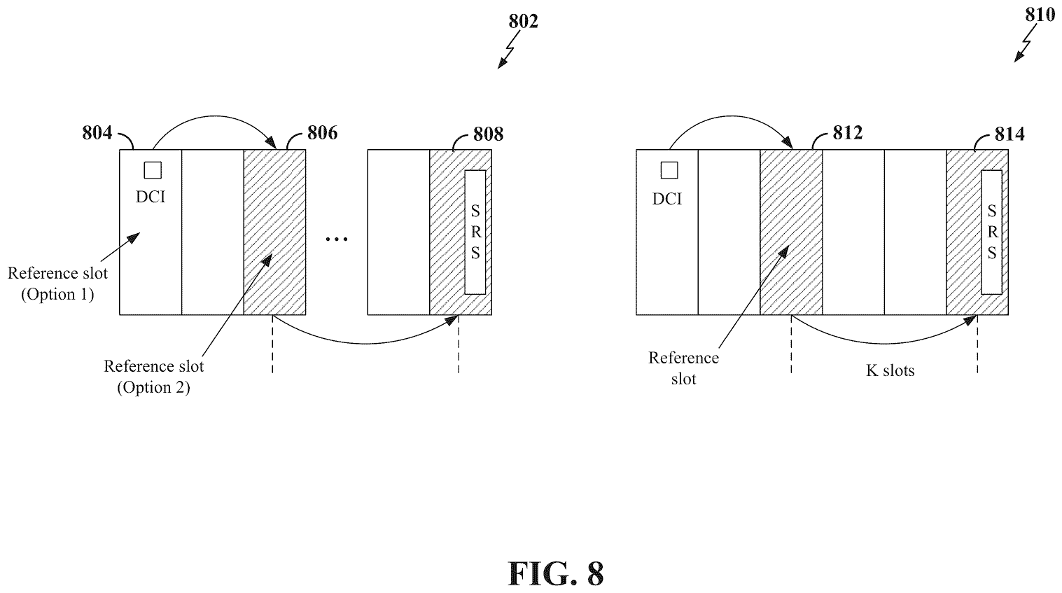

Referring to FIG. 8, an A-SRS resource set may be transmitted in the k-th slot counting from a reference slot, where k is determined from the DCI. As shown in a first example 802 of FIG. 8, the reference slot may be the slot with the triggering DCI (e.g., slot 804) in some examples (Option 1). In other examples, the reference slot (e.g., slot 806) is the slot indicated by the legacy triggering offset (Option 2). A reference slot may serve as the starting point for a minimum offset to the k-th available slot in which the SRS is transmitted. For example, the reference slot 806 may serve as the starting point for a minimum offset to the k-th available slot 808. In this case, the count of k slots only includes UL slots in some examples. As shown in a second example 810 of FIG. 8, a reference slot 812 may serve as the starting point for an absolute offset to the k-th slot 814 in which the SRS is transmitted. In this case, the count of k slots includes both UL and DL slots in some examples.

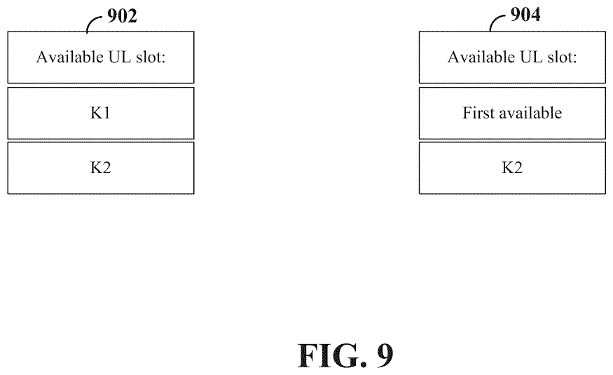

The disclosure relates in some aspect to configuration of a valid/available slot for an SRS transmission. Here, an RRC configuration may be provided for each SRS resource set within each BWP for every cell. In some examples, the RRC configuration specifies up to 2 configured values (K1 and K2) of the candidates of the next available slot as shown in the example 902 of FIG. 9. In some examples, the range of each configured value is 0 to N slots in integer values where 0 represents the first available slot and N refers to the Nth available slot. In some examples, the value of N depends on the numerology (e.g., 15 kHz, 30 kHz, . . . ) used. In some examples, the available slot is based on the BWP's numerology.

In some examples, the RRC configuration may include 1 configured value (K2) as shown in the example 904 of FIG. 9. Here, configuring one value in the table may be interpreted as being equivalent to configuring a table of two values where the first value means the first available slot (e.g., the first available UL slot). A particular value (e.g., zero) may be defined to indicate the first available slot.

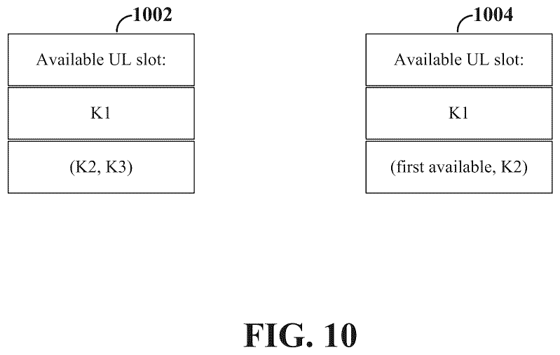

The disclosure relates in some aspect to configuration of up to 3 values (e.g., using 2 table entries) as shown in the examples 1002 and 1004 of FIG. 10. Here the configuration of the valid/available UL slot may be similar to the configuration of FIG. 9 with the exception that there may be up to 3 RRC-configured values of the candidates of the next available slot for an SRS transmission. Here, the first entry may indicate one UL slot (K1). In some examples, the second entry may indicate two possible UL slots (e.g., K2 and K3 as shown in the example 1002. In some examples, the second entry may indicate K2 and value of 0 (or some other value) for an indication of the first available slot as shown in the example 1004.

A UE may use one or more of the following techniques to select between the two parameters in the second entry (e.g., select between K2 and K3 or select between K2 and an indication of the first available slot). In a first technique (Option 1), the smallest value {K2, K3} is selected. In some examples, if an UL transmission is not possible on the slot indicated by a first value (e.g., K2) that was selected (e.g., the smallest value), then the second value (e.g., K3) is selected. In some examples, if the first available transmission is configured, then it is selected first. In a second technique (Option 2), the selection is based on at least one higher layer parameter (e.g., an RRC configured parameter). In some examples, the higher layer parameter is the SRS frequency allocation (e.g., if the number of allocated RBs<threshold, use the first value). For example, if the network (e.g., a gNB) configures several UEs with narrowband allocations, the network may elect to frequency multiplex these UEs. In this case, the network may specify that each of these UEs is to transmit its SRS at the earliest of the RRC configured slots. In some examples, the second value may be selected if frequency hopping is configured for the triggered SRS resource set. For example, the first value might point to a slot with only one SRS symbol (which would be insufficient for frequency hopping). Thus, a UE might use the slot indicated by the second value (e.g., which may have multiple consecutive symbols available for SRS).

The disclosure relates in some aspect to signaling using a UE-specific data-scheduling DCI. In some examples, a 1-bit indication may be included in the scheduling DCI (e.g., DCI Format 0_1, 1_1, 0_2, and 1_2) to select the valid UL slot (or SRS delay offset) for the triggered A-SRS set. This 1 bit indication may be explicit (e.g., a new DCI bit field) or implicitly indicated by another bit field (e.g., an existing bit field such as an SRS trigger field or a time domain resource allocation (TDRA) field is repurposed). In some examples, the UE may be configured with multiple SRS trigger states where each trigger state value is associated with one value of an available slot. In some examples, one bit of a two-bit field of an SRS trigger state is used to indicate one of the two configured values of an available slot. In some aspects, a time domain resource allocation (TRDA) table includes the configured values of the available UL slot and the DCI bit-field of the time domain resource assignment will indicate the selected available UL slot.

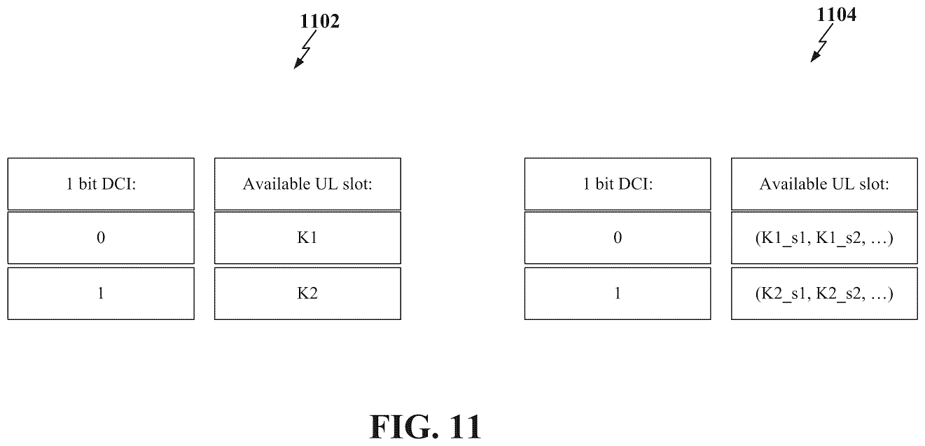

In some examples, the delay applies to ‘all’ triggered SRS resource sets (e.g., all of the SRS resource sets triggered by a DCI). For example, all of the triggered SRS resource sets may use the K1^{th} or K2^{th} available slot for transmitting the SRS as shown in the first example 1102 of FIG. 11 where this table is configured per each bandwidth part. As another example, for the scenario where 1 value is configured (e.g., as discussed above) a bit value=‘1’ may indicate the configured value and a bit value=‘0’ may indicate the “first available slot.” An RRC configuration per SRS resource set may indicate whether this delay applies to all SRS resource sets or not. In some scenarios, the RRC parameter is the list of the T values where a gNB may not configure the list of available slots per SRS resource set. In some scenarios, the RRC parameter could be configured per-BWP as an indication of the gNB supporting the SRS transmission delay scheme.

Alternatively, for finer granularity, the RRC table may indicate different values of an UL slot for each SRS resource set. For example, as shown in the second example 1104 of FIG. 11, if the bit value=‘0’ the first SRS resource set may use delay value K1_s1, the second SRS resource set may use delay value K1_s2, and so on. In some examples, K1_s1, K1_s2, etc., may be staggered. Conversely, if the bit value=‘1’ the first SRS resource set may use delay value K2_s1, the second SRS resource set may use delay value K2_s2, and so on. In some aspects, this may be equivalent to configuring a separate set of available slot values per each SRS resource set.

In some examples, the network may utilize a non-scheduling DCI that may carry a bit field for an SRS delay. In this case, the bit field may be larger than 1 bit (e.g., table size>2 entries) to enable the network to select a value from multiple candidates of ‘available’ slots.

The disclosure relates in some aspect to a DCI where the bit field is absent, the bit field points to a non-configured delay value, or the bit field is disabled. In some examples (Option 1), the UE may fall back to legacy behavior where the UE does not postpone or delay the SRS transmission (e.g., where the UE instead sends the SRS at the legacy slot offset). This option provides backward compatibility. In some examples (Option 2), the delay may be implicit. For example, an RRC configured delay value may be used (e.g., one dedicated delay value in the list of available slots) when the bit field is absent, maps to non-configured delay value, or is disabled. As another example, the UE may use the first available UL slot (e.g., corresponding to t=0) when the bit field is absent, maps to a non-configured delay value, or is disabled.

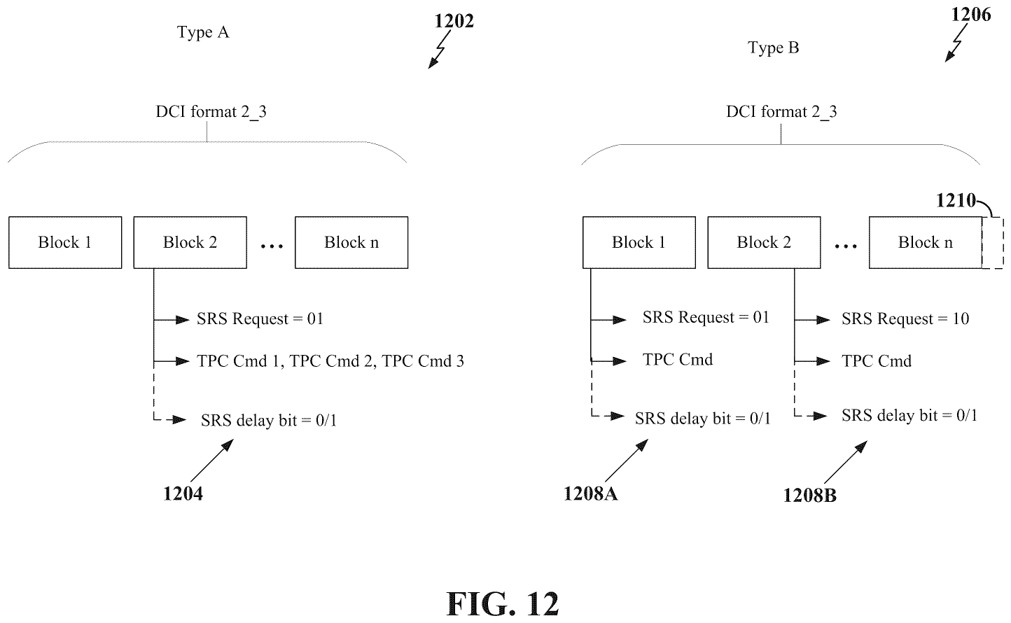

The disclosure relates in some aspect to a DCI indicated delay value in the context of SRS carrier switching. Here, a UE may switch its UL transmission from one serving cell to another (without UL PUSCH and PUCCH) for transmitting an A-SRS signal using ‘antennaSwitching.’ DCI format 2_3 may be used for the transmission of a group of transmit power control (TPC) commands for SRS transmissions by one or more UEs. Along with a TPC command, an SRS request may also be transmitted. The contents of the SRS may be multiple blocks: block1, block2, . . . blockn as shown in FIG. 12.

There are two types of DCI format 2_3: Type-A and Type-B. In DCI format 2_3 Type-A, a UE is configured with one block which applies a component carrier (CC) set and contains an SRS request (0,2 bits) to determine the CC set, along with N TPC commands for each CC in the set. As indicated in a first example 1202 of FIG. 12, the configured block may include a bit field 1204 for SRS delay information as discussed herein.

In DCI format 2_3 Type-B, a UE is configured with one or more blocks. Each block applies to one UL carrier and contains an SRS request (0,2 bits) to determine the SRS resource set(s), along with a TPC command (2 bits). As indicated in the second example 1206 of FIG. 12, each block may include a bit field 1208A, 1208B, etc., for SRS delay information as discussed herein.

The disclosure relates in some aspect to using a group common DCI with a 1-bit indication in a scheduling DCI (e.g., Format 2_3) to select the valid UL slot (or SRS delay offset) for the triggered A-SRS. The block size contains 1 extra bit along with previous entries as shown in FIG. 12. In some examples, this delay may apply to ‘all’ triggered SRS resource sets. In some examples, the same value applies to triggered sets (e.g., as shown in the first example 1102 of FIG. 11). An RRC configuration per SRS resource set may indicate whether this delay applies to all SRS resource sets or not.

Alternatively, for finer granularity, the RRC table may indicate different values of an UL slot for each SRS resource set. For example, as shown in the second example 1104 of FIG. 11, if the bit value=‘0’ the first SRS resource set may use delay value K1_s1, the second SRS resource set may use delay value K1_s2, and so on. Conversely, if the bit value=‘1’ the first SRS resource set may use delay value K2 s1, the second SRS resource set may use delay value K2_s2, and so on. In some aspects, this may be equivalent to configuring a separate set of available slot values per each SRS resource set.

For backward compatibility, the UE may be RRC configured with a pointer (e.g., DCIPosition) that refers to an appended bit field 1210 at the tail of the DCI payload as shown in FIG. 12. In some examples, the bit field 1210 may be 1 bit. In some examples, the bit field 1210 may include an entry for each block (e.g., for block1, block2 . . . blockn the bit field 1210 may be 1, 1, . . . 0, etc.). In some examples, to reduce overhead, two or more blocks may be mapped to the same bit of the bit field (e.g., for block1, block1 . . . blockn the bit field 1210 may be 1, 0 where blocks 1 and 2 map to the first bit and blocks 3-n map to the second bit).

The disclosure relates in some aspect to using a medium access control-control element (MAC-CE) to update the candidates of the ‘available’ slot offset. The MAC-CE may update/add/delete entries of the RRC configured table. The MAC-CE may update the tables for all SRS resource set(s) within each BWP of a serving cell. The MAC-CE may update the table for multiple CCs (one or more serving cells). As mentioned above, a separate table may be configured for each SRS resource set.

The disclosure relates in some aspect to an improved definition of an available UL slot. In some examples, a slot may be deemed valid if there are available UL symbol(s) for the configured time-domain location(s) in a slot for all the SRS resources in the resource set and if the slot satisfies the minimum timing requirement (e.g., minimum UE DCI processing time) between the triggering PDCCH and all the SRS resources in the resource set.

For an unpaired spectrum (TDD) scenario, the following test may be used in some examples. A valid (available) UL slot is an uplink (U), special (S) or flexible (F) slot. A valid UL slot is the slot where the aperiodic SRS does not collide with another scheduled transmission (regardless of priority) and there is no change of the active BWP between the time the DCI is received to the available slot. A valid UL slot is a slot where an SFI that changes some flexible symbols or slots has not been received (e.g., after the reception of the DCI triggering the aperiodic SRS resource set).

For a paired spectrum (FDD) scenario, the following test may be used in some examples. A valid (available) UL slot is a U or F slot. A valid UL slot does not collide with another scheduled transmission (regardless of priority) and there is no change of the active BWP between the time the DCI is received to the available slot.

The disclosure relates in some aspect to a DCI with an SRS delay or SRS transmission indication for a paired spectrum scenario where different frequency spectrum are configured with different subcarrier spacings (SCSs). Here, a UE may receive a DCI on a DL channel and transmit an SRS on an UL channel.

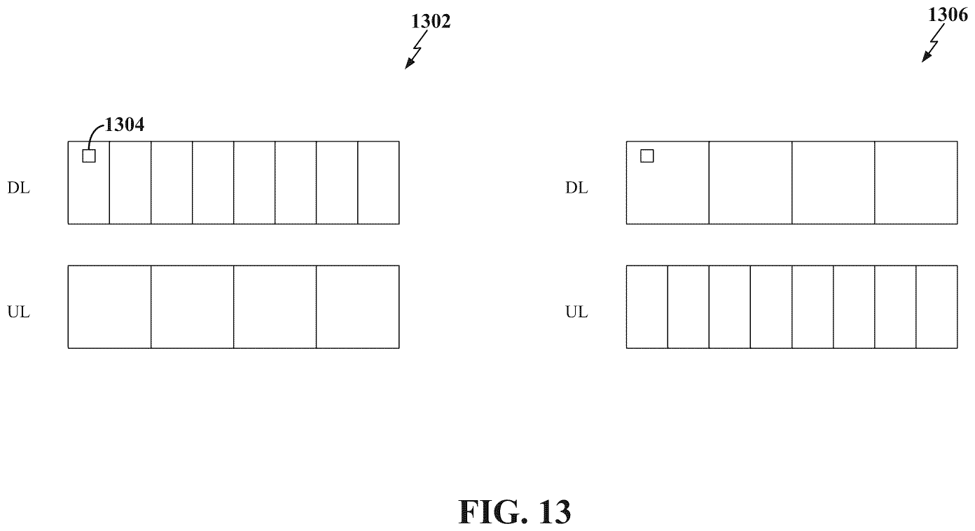

For FDD with different DL and UL SCSs as shown in FIG. 13, a valid slot (K) may be determined based on UL numerology (Case 1) or based on DL numerology (Case 2). In a first example 1302, the DL spectrum has a larger subcarrier spacing (SCS) than the UL spectrum. In a second example 1306, the DL spectrum has a smaller SCS than the UL spectrum.

Equations 1 and 2 below may be used to identify the slot in the UL channel for transmission of SRS. For Case 1, the slot carrying the scheduling DCI 1304 may be mapped to the UL numerology using Equation 1, where k is the legacy slot offset. The SRS transmission will happen at the indicated Kth available slot where all UL slots are considered available in paired spectrum.

Ceil(n*2\hat{ }μ_{UL}/2\hat{ }μ_{DL})+k+K EQUATION 1

For Case 2, the parameter K may be mapped to the UL numerology using the second part of Equation 2.

Ceil(n*2\hat{ }μ_{UL}/2\hat{ }μ_{DL})+k+Ceil(K*2\hat{ }μ_{DL}/2\hat{ }μ_{UL}) EQUATION 2

The disclosure relates in some aspect to a DCI with an SRS transmission indication for a cross carrier scenario where different CCs are configured with different SCSs. An UL/DL scheduling DCI can be received at a serving CC (e.g., a first CC) for scheduling data on a different CC (e.g., a second CC) and triggering A-SRS at that CC (e.g., the second CC).

The DCI can carry an indication (e.g., a 1-bit indication) to select the valid UL slot (or SRS delay offset) for the triggered A-SRS resource set. In this case, the numerology may be converted between the two CCs to determine the reference slot and the available slot for SRS transmission. In some examples, the equations that follow may be used to translate the DCI slot (n) that has been received on a first CC based on the ratio of the numerology of the second CC where the SRS is to be transmitted over the numerology of the first CC where the DCI is received. The parameter k is then added to determine the slot for the SRS transmission on the second CC.

If the UE receives the DCI triggering aperiodic ‘SRS in slot n’ and except when SRS is configured with the higher layer parameter SRS-PosResource-r16, the UE transmits aperiodic SRS in each of the triggered SRS resource set(s) in slot:

$$⌊ n \frac{{2}^{μ S R S}}{{2}^{μ PDCCH}} ⌋ + k + ⌊ ( \frac{{N}_{s l o t , offset , PDCCH}^{CA}}{{2}^{μ offset , PDCCH}} - \frac{{N}_{slot , offset , SRS}^{CA}}{{2}^{μ offset , SRS}} ) \cdot {2}^{μ SRS} ⌋ , \qquad EQUATION 3$$

if the UE is configured with ca-SlotOffset for at least one of the triggered and triggering cell.

The UE uses:

$${K}_{S} = ⌊ n \frac{{2}^{μ S R S}}{{2}^{μ P D C C H}} ⌋ + k , otherwise . \qquad EQUATION 4$$

Here, k is configured via the higher layer parameter slotOffset for each triggered SRS resource set and is based on the subcarrier spacing of the triggered SRS transmission, μSRS and μPDCCH are the subcarrier spacing configurations for triggered SRS and PDCCH carrying the triggering command, respectively.

The parameters N_{slot,offset,PDCCH}^{CA} and μ_{offset,PDCCH} are the N_{slot,offset,SRS}^{CA} and the μ_{offset}, respectively, which are determined by the higher-layer configured ca-SlotOffset for the cell receiving the PDCCH. The parameters N_{slot,offset,SRS}^{CA} and μ_{offset,SRS} are the N_{slot,offset}^{CA} and the μ_{offset}, respectively, which are determined by higher-layer configured ca-SlotOffset for the cell transmitting the SRS.

In the above example, the reference slot may be defined in two ways in two scenarios. In a first scenario (Scenario 1), the UE is not configured with ca-SlotOffset. In this case, the reference slot is given by

$$⌊ n \frac{{2}^{μ S R S}}{{2}^{μ PDCCH}} ⌋ + k offset ,$$

where the slot offset is based on the numerology of the scheduled cell, and the RRC table and entries are based on the scheduled cell. This scenario determines the reference slot taking into account the numerology change between CCs.

In the second scenario (Scenario 2), the UE is configured with ca-slotOffset. In this case, the reference slot is given by:

$$⌊ n \frac{{2}^{μ S R S}}{{2}^{μ PDCCH}} ⌋ + k + ⌊ ( \frac{{N}_{s l ot , offset , PDCCH}^{CA}}{{2}^{μ offset , PDCCH}} - \frac{{N}_{slot , offset , SRS}^{CA}}{{2}^{μ offset , SRS}} ) \cdot {2}^{μ S R S} ⌋ \qquad EQUATION 5$$

The SRS is then transmitted at the scheduled cell at the Kth available UL slot after the reference slot as indicated by the DCI, where K is RRC configured as discussed in example 902 or 904 in FIG. 9. This scenario determines the reference slot taking into account the numerology change between CCs and also taking into account the offset between the non-aligned slots of the CCs (e.g., as indicated by ca-SlotOffset).

In some aspect, the reference slot is based on the slot where the triggering DCI is received and is given by:

$$⌊ n \frac{{2}^{μ S R S}}{{2}^{μ PDCCH}} ⌋ \qquad EQUATION 6$$

if the UE is not configured with-ca-SlotOffset; otherwise:

$$⌊ n \frac{{2}^{μ S R S}}{{2}^{μ PDCCH}} ⌋ + ⌊ ( \frac{{N}_{s l ot , offset , PDCCH}^{CA}}{{2}^{μ offset , PDCCH}} - \frac{{N}_{slot , offset , SRS}^{CA}}{{2}^{μ offset , SRS}} ) \cdot {2}^{μ S R S} ⌋ \qquad EQUATION 7$$

if the UE is configured with ca-SlotOffset.

The SRS is transmitted at the t^{th} available slot after the reference slot.

In some examples, in the event a UE switches to a new carrier, the UE may refrain from postponing or delaying the SRS transmission on the new carrier.

In some examples, in the event a UE switches to a carrier that is configured without PUSCH and without PUCCH, the UE may transmit SRS at the first available slot after switching to that carrier.

In some examples, the delay value described herein may be an ‘absolute’ delay by ‘K’ slots instead of the available ‘kth’ slot. In some examples, the techniques described herein may be used where the RRC table indicates the absolute shift or delay from the reference slot. In case no DCI SRS delay field is indicated, it may be assumed that k=0 and the SRS transmission may occur at the reference slot. In the event the indicated slot is not valid, then the SRS may be implicitly transmitted at the first available UL slot.

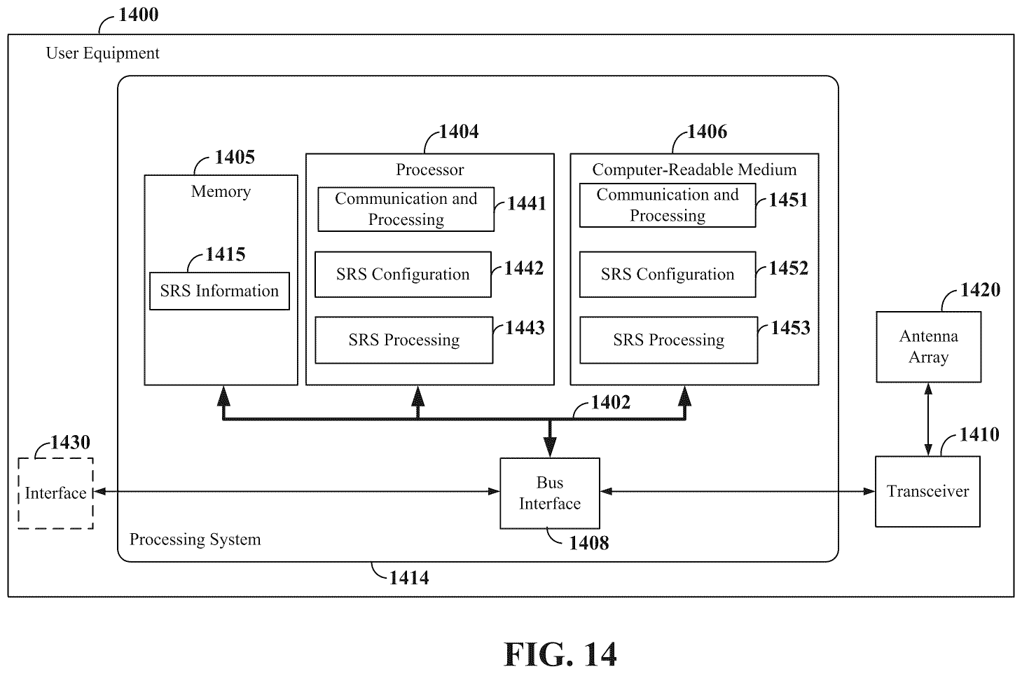

FIG. 14 is a block diagram illustrating an example of a hardware implementation for a UE 1400 employing a processing system 1414. For example, the UE 1400 may be a device configured to wirelessly communicate with a base station, as discussed in any one or more of FIGS. 1-13. In some implementations, the UE 1400 may correspond to any of the UEs or scheduled entities shown in any of FIGS. 1, 2, 4, and 5.

In accordance with various aspects of the disclosure, an element, or any portion of an element, or any combination of elements may be implemented with the processing system 1414. The processing system 1414 may include one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1400 may be configured to perform any one or more of the functions described herein. That is, the processor 1404, as utilized in a UE 1400, may be used to implement any one or more of the processes and procedures described herein.

The processor 1404 may in some instances be implemented via a baseband or modem chip and in other implementations, the processor 1404 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 communicatively couples together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further. A bus interface 1408 provides an interface between the bus 1402 and a transceiver 1410 and between the bus 1402 and an interface 1430. The transceiver 1410 provides a communication interface or means for communicating with various other apparatus over a wireless transmission medium. In some examples, the UE may include two or more transceivers 1410. The interface 1430 provides a communication interface or means of communicating with various other apparatuses and devices (e.g., other devices housed within the same apparatus as the UE or other external apparatuses) over an internal bus or external transmission medium, such as an Ethernet cable. Depending upon the nature of the apparatus, the interface 1430 may include a user interface (e.g., keypad, display, speaker, microphone, joystick). Of course, such a user interface is optional, and may be omitted in some examples, such as an IoT device.

The processor 1404 is responsible for managing the bus 1402 and general processing, including the execution of software stored on the computer-readable medium 1406. The software, when executed by the processor 1404, causes the processing system 1414 to perform the various functions described below for any particular apparatus. The computer-readable medium 1406 and the memory 1405 may also be used for storing data that is manipulated by the processor 1404 when executing software. For example, the memory 1405 may store SRS information 1415 (e.g., SRS time occasion parameters) used by the processor 1404 to transmit an SRS.

One or more processors 1404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1406.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

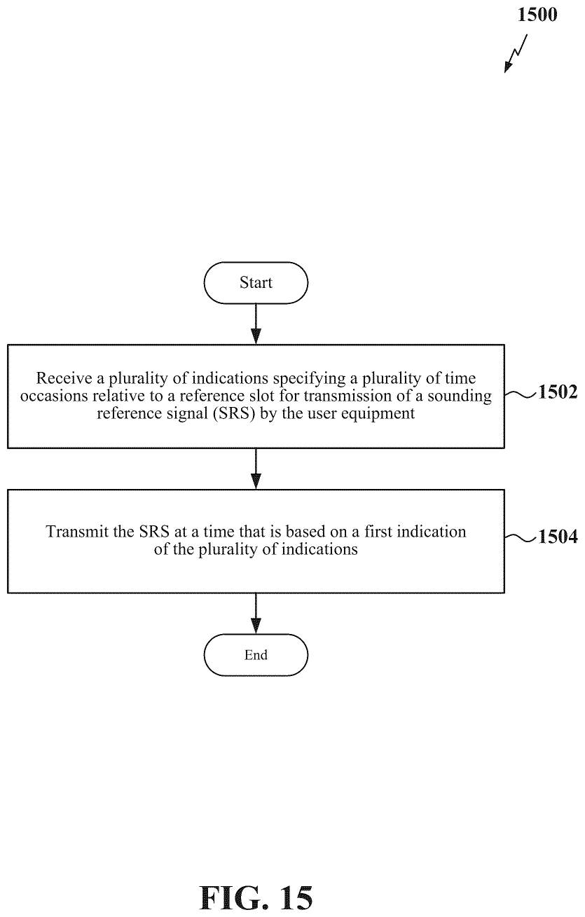

The UE 1400 may be configured to perform any one or more of the operations described herein (e.g., as described above in conjunction with FIGS. 1-13 and as described below in conjunction with FIGS. 15-23). In some aspects of the disclosure, the processor 1404, as utilized in the UE 1400, may include circuitry configured for various functions.

The processor 1404 may include communication and processing circuitry 1441. The communication and processing circuitry 1441 may be configured to communicate with a base station, such as a gNB. The communication and processing circuitry 1441 may include one or more hardware components that provide the physical structure that performs various processes related to wireless communication (e.g., signal reception and/or signal transmission) as described herein. The communication and processing circuitry 1441 may further include one or more hardware components that provide the physical structure that performs various processes related to signal processing (e.g., processing a received signal and/or processing a signal for transmission) as described herein. In some examples, the communication and processing circuitry 1441 may include two or more transmit/receive chains, each configured to process signals in a different RAT (or RAN) type. The communication and processing circuitry 1441 may further be configured to execute communication and processing software 1451 included on the computer-readable medium 1406 to implement one or more functions described herein.

The communication and processing circuitry 1441 may further be configured to generate and transmit a request to the base station. For example, the request may be included in a MAC-CE carried in a PUSCH, UCI in a PUCCH or PUSCH, a random access message, or an RRC message. The communication and processing circuitry 1441 may further be configured to generate and transmit a scheduling request (e.g., via UCI in a PUCCH) to the base station to receive an uplink grant for a PUSCH.

The communication and processing circuitry 1441 may further be configured to generate and transmit an uplink signal. The uplink signal may include, for example, a PUCCH, PUSCH, SRS, DMRS, or physical random access channel (PRACH).

In some implementations where the communication involves receiving information, the communication and processing circuitry 1441 may obtain information from a component of the UE 1400 (e.g., from the transceiver 1410 that receives the information via radio frequency signaling or some other type of signaling suitable for the applicable communication medium), process (e.g., decode) the information, and output the processed information. For example, the communication and processing circuitry 1441 may output the information to another component of the processor 1404, to the memory 1405, or to the bus interface 1408. In some examples, the communication and processing circuitry 1441 may receive one or more of signals, messages, other information, or any combination thereof. In some examples, the communication and processing circuitry 1441 may receive information via one or more channels. In some examples, the communication and processing circuitry 1441 may include functionality for a means for receiving. In some examples, the communication and processing circuitry 1441 may include functionality for a means for decoding.

In some implementations where the communication involves sending (e.g., transmitting) information, the communication and processing circuitry 1441 may obtain information (e.g., from another component of the processor 1404, the memory 1405, or the bus interface 1408), process (e.g., encode) the information, and output the processed information. For example, the communication and processing circuitry 1441 may output the information to the transceiver 1410 (e.g., that transmits the information via radio frequency signaling or some other type of signaling suitable for the applicable communication medium). In some examples, the communication and processing circuitry 1441 may send one or more of signals, messages, other information, or any combination thereof. In some examples, the communication and processing circuitry 1441 may send information via one or more channels. In some examples, the communication and processing circuitry 1441 may include functionality for a means for sending (e.g., a means for transmitting). In some examples, the communication and processing circuitry 1441 may include functionality for a means for encoding.

The processor 1404 may include SRS configuration circuitry 1442 configured to perform SRS configuration-related operations as discussed herein (e.g., one or more of the operations described in conjunction with FIGS. 8-13). The SRS configuration circuitry 1442 may be configured to execute SRS configuration software 1452 included on the computer-readable medium 1406 to implement one or more functions described herein.

The SRS configuration circuitry 1442 may include functionality for a means for receiving indications (e.g., as described at FIGS. 8-11, and/or at block 1502 of FIG. 15). For example, the SRS configuration circuitry 1442 together with the communication and processing circuitry 1441 and the transceiver 1410 may receive an RRC message that includes a table with K1 or K2.

The SRS configuration circuitry 1442 may include functionality for a means for selecting an indication (e.g., as described at FIGS. 11-13, and/or at block 1504 of FIG. 15). For example, the SRS configuration circuitry 1442 may select K1 or K2 based on an indication in a DCI that triggered an SRS transmission.

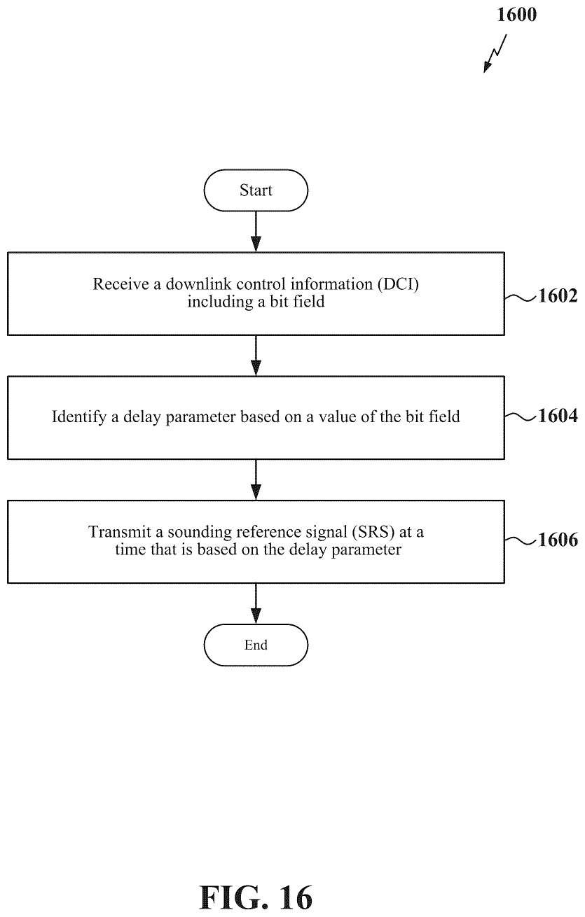

The SRS configuration circuitry 1442 may include functionality for a means for receiving a DCI (e.g., as described at FIGS. 5-8, 13, and 14, and/or at block 1602 of FIG. 16). For example, the SRS configuration circuitry 1442 together with the communication and processing circuitry 1441 and the transceiver 1410 may monitor for a DCI that triggers an SRS on a specified channel (e.g., PDCCH).

The SRS configuration circuitry 1442 may include functionality for a means for identifying (e.g., setting) a delay parameter (e.g., as described at FIGS. 11-13, and/or at block 1604 of FIG. 16). For example, the SRS configuration circuitry 1442 may decode and parse a received DCI to determine the value (e.g., 0 or 1) of a bit field for determining a delay to be applied to an SRS transmission triggered by the DCI. As another example, the SRS configuration circuitry 1442 may decode and parse a received DCI to determine whether the DCI includes a bit field for a DCI delay value indication. If the DCI does not include the bit field, the SRS configuration circuitry 1442 may select a delay value of zero (e.g., a legacy/backward compatible procedure is followed where the SRS is not postponed/delayed). In some aspects, a delay value of zero will cause the SRS to be transmitted in the first available UL slot. As yet another example, the SRS configuration circuitry 1442 may decode and parse a received DCI to determine whether the DCI bit field for a DCI delay value indication maps to a configured delay value. If the DCI bit field does not map to the configured delay value, the SRS configuration circuitry 1442 may select a default delay value (e.g., that is based on an RRC configured ‘t’ value).

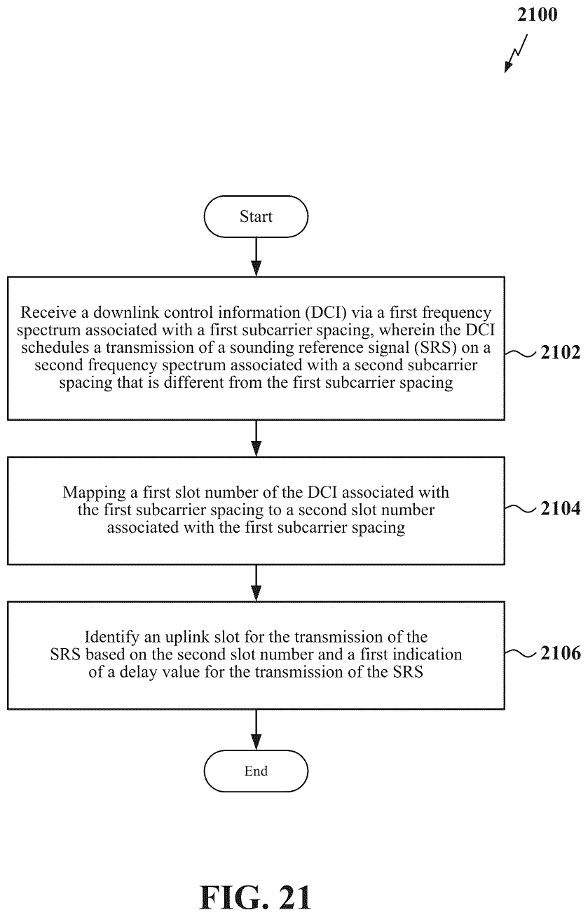

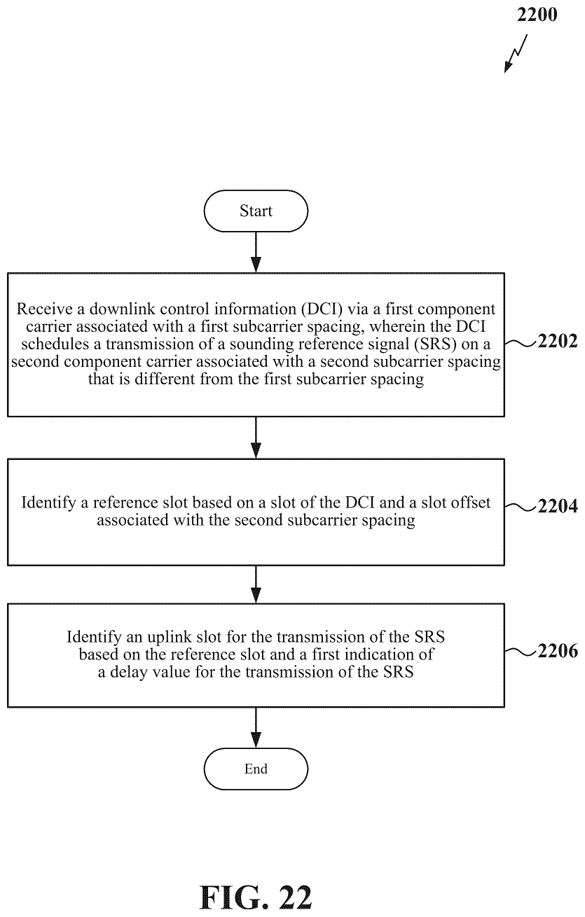

The SRS configuration circuitry 1442 may include functionality for a means for mapping (e.g., as described at FIGS. 12-13, and/or at block 2104 of FIG. 21). The SRS configuration circuitry 1442 may include functionality for a means for identifying a reference slot (e.g., as described at FIGS. 12-13, and/or at block 2204 of FIG. 22).

The processor 1404 may include SRS processing circuitry 1443 configured to perform SRS processing-related operations as discussed herein (e.g., one or more of the operations described in conjunction with FIGS. 8-13). The SRS processing circuitry 1443 may be configured to execute SRS processing software 1453 included on the computer-readable medium 1406 to implement one or more functions described herein.

The SRS processing circuitry 1443 may include functionality for a means for generating an SRS (e.g., as described at FIGS. 5-8). The SRS processing circuitry 1443 may include functionality for a means for transmitting an SRS (e.g., as described at FIGS. 5-8, 13, and 14 and/or at block 1506 of FIG. 15 and/or at block 1606 of FIG. 16). For example, the SRS processing circuitry 1443 together with the communication and processing circuitry 1441 and the transceiver 1410 may transmit an SRS on a designated SRS resource set during an available slot.

FIG. 15 is a flow chart illustrating an example wireless communication method 1500 in accordance with some aspects of the present disclosure. As described below, some or all illustrated features may be omitted in a particular implementation within the scope of the present disclosure, and some illustrated features may not be required for implementation of all examples. In some examples, the wireless communication method 1500 may be carried out by the UE 1400 illustrated in FIG. 14. In some examples, the wireless communication method 1500 may be carried out by any suitable apparatus or means for carrying out the functions or algorithm described below.

At block 1502, a UE may receive a plurality of indications specifying a plurality of time occasions relative to a reference slot for transmission of a sounding reference signal (SRS) by the user equipment. For example, the SRS configuration circuitry 1442 together with the communication and processing circuitry 1441 and the transceiver 1410, shown and described above in connection with FIG. 14, may provide a means to receive a plurality of indications specifying a plurality of time occasions relative to a reference slot for transmission of a sounding reference signal (SRS) by the user equipment.

At block 1504, the UE may transmit the SRS at a time that is based on a first indication of the plurality of indications. For example, the SRS processing circuitry 1443 together with the communication and processing circuitry 1441 and the transceiver 1410, shown and described above in connection with FIG. 14, may provide a means to transmit the SRS at a time that is based on a first indication of the plurality of indications.

In some examples, the reference slot is a slot in which a downlink control information (DCI) is received. In some examples, the reference slot follows a downlink control information (DCI) by a quantity of slots that is specified by a radio resource control (RRC) configuration.

In some examples, the plurality of indications may include a first delay value, and a second delay value. In some examples, the first delay value may include a second indication to a first available slot, and the second delay value may include a third indication to a second available slot that is different from the first available slot.

In some examples, the plurality of indications may include a first delay value, and an indication to use a first available slot. In some examples, the indication to use the first available slot may include a value of zero.

In some examples, the plurality of indications are for a specified SRS resource set. In some examples, a time domain behavior of the specified SRS resource set is aperiodic.

In some examples, receiving the plurality of indications may include receiving a radio resource control (RRC) configuration that includes a first field and a second field for the plurality of indications.

In some examples, the plurality of indications may include a first field that includes a first delay value, and a second field that includes a second delay value and a third delay value. In some examples, the first delay value may include a second indication to a first available slot, the second delay value may include a third indication to a second available slot that is different from the first available slot, and the third delay value may include a fourth indication to a third available slot that is different from the second available slot.

In some examples, the plurality of indications may include a first field that includes a first delay value, and a second field that includes a second delay value and an indication to use a first available slot. In some examples, the indication to use the first available slot may include a value of zero.

In some examples, the UE may select the first indication. In some examples, selecting the first indication may include determining that the first indication is a smaller number than a second indication of the plurality of indications, and selecting the first indication based on the determining that the first indication is a smaller number than the second indication.

In some examples, selecting the first indication may include determining that an uplink transmission should not be performed during a slot indicated by a second indication of the plurality of indications, and selecting the first indication based on the determining that the uplink transmission should not be performed during the slot indicated by the second indication.

In some examples, selecting the first indication may include determining that the first indication may include an indication to use a first available slot, and selecting the first indication based on the determining that the first indication may include the indication to use the first available slot.

In some examples, selecting the first indication may include receiving an indication selection parameter, and selecting the first indication based on the indication selection parameter.

In some examples, selecting the first indication may include determining that a size of a resource allocation for the transmission of the SRS is less than a threshold, and selecting the first indication based on the determining that the size of the resource allocation for the transmission of the SRS is less than the threshold.

In some examples, selecting the first indication may include determining whether frequency hopping is configured for the transmission of the SRS, and selecting the first indication based on the determining whether frequency hopping is configured for the transmission of the SRS.

In some examples, selecting the first indication may include receiving a downlink control information (DCI) including a bit field, and selecting the first indication based on a value of the bit field. In some examples, the DCI may include a data scheduling DCI format 0_1, a DCI format 0_1, a DCI format 0_2, a DCI format 1_1, or a DCI format 1_2. In some examples, the bit field is a single bit.

In some examples, the plurality of indications map a first value of the bit field to a first delay value for the transmission of the SRS, and a second value of the bit field to a second delay value for the transmission of the SRS. In some examples, the plurality of indications map a first value of the bit field to a first delay value for the transmission of the SRS, and a second value of the bit field to an indication to use a first available slot for the transmission of the SRS.

In some examples, the bit field is dedicated for indicating which of a plurality of delay values is to be used for the transmission of the SRS.

In some examples, the bit field is reallocated for indicating which of a plurality of delay values is to be used for the transmission of the SRS. In some examples, an SRS request field is used to indicate the bit field.

In some examples, the UE may receive a message specifying that the value of the bit field applies to all of a plurality of SRS resource sets defined for a bandwidth part. In some examples, the message may include a radio resource control (RRC) configuration.

In some examples, the UE may receive a message specifying that the value of the bit field applies to a subset of a plurality of SRS resource sets defined for a bandwidth part. In some examples, the plurality of indications map a first value for the bit field to a first delay value for a first SRS resource set of the plurality of SRS resource sets, the first value for the bit field to a second delay value for a second SRS resource set of the plurality of SRS resource sets, a second value for the bit field to a third delay value for the first SRS resource set of the plurality of SRS resource sets, and the second value for the bit field to a fourth delay value for the second SRS resource set of the plurality of SRS resource sets.

In some examples, the DCI triggers the transmission of the SRS and does not schedule a data transmission. In some examples, the bit field is a plurality of bits. In some examples, the bit field is a plurality of bits where one bit of the plurality of bits is mapped to each triggered SRS resource set. In some examples, the bit field is a plurality of bits where each bit of the plurality of bits is mapped to a respective triggered SRS resource set.

In some examples, the UE may receive a group common downlink control information (DCI), wherein the group common DCI includes a bit field for indicating at least one delay parameter for the transmission of the SRS, wherein selecting the first indication may include selecting the first indication based on a value of the bit field.

In some examples, the group common DCI is a format 2_3 DCI and the group common DCI may include a component carrier block that includes the bit field. In some examples, the group common DCI is a format 2_3 DCI, and the group common DCI may include a payload that includes the bit field, and the bit field may include a plurality of bits that are mapped to a plurality of component carriers scheduled by the group common DCI.

In some examples, the UE may receive a radio resource control (RRC) message including a pointer that maps a first bit of the bit field to at least a first component carrier of the plurality of component carriers, and a second bit of the bit field to at least a second component carrier of the plurality of component carriers.

In some examples, the UE may receive a radio resource control (RRC) message specifying that the bit field applies to all of a plurality of SRS resource sets defined for a bandwidth part. In some examples, the UE may receive a radio resource control (RRC) message specifying that the bit field applies to a subset of a plurality of SRS resource sets defined for a bandwidth part. In some examples, the UE may receive a first radio resource control (RRC) message specifying that the bit field applies to a first subset of a plurality of SRS resource sets defined for a bandwidth part, and receive a second resource control (RRC) message specifying that the bit field applies to a second subset of the plurality of SRS resource sets defined for the first bandwidth part.

In some examples, the UE may receive a medium access control-control element (MAC-CE) including a modification of the plurality of indications. In some examples, the modification of the plurality of indications may include an update of at least one of the plurality of indications, an addition of at least one indication to the plurality of indications, or a deletion of at least one of the plurality of indications. In some examples, the modification of the plurality of indications may include modification of the plurality of indications for all SRS resource sets for each bandwidth part of each serving cell of a base station. In some examples, the modification of the plurality of indications may include modification of the plurality of indications for all SRS resource sets for a plurality of component carriers.

In some examples, the UE may determine an available slot for transmission of the SRS based on the first indication, wherein transmitting the SRS at a time that is based on the first indication may include transmitting the SRS during the available slot.

In some examples, the UE may verify that a candidate slot indicated by the first indication is defined as an uplink slot, a special slot, or a flexible slot with sufficient time-domain and frequency-domain allocation for the transmission of the SRS, verify that the transmission of the SRS does not collide with a higher priority uplink signal or uplink channel scheduled during the candidate slot, verify that there is no change of an active bandwidth after a triggering DCI is received, verify that a slot format indicator was not received after the plurality of indications was received, or a combination thereof. In some examples, determining the available slot may include at least one of verifying that a candidate slot indicated by the first indication is defined as an uplink slot, a special slot, or a flexible slot with sufficient time-domain and frequency-domain allocation for the transmission of the SRS (e.g., for any one of the U slot, the S slot, or the F slot), verifying that SRS transmission (e.g., the transmission of the SRS) does not collide with a higher priority uplink signal or uplink channel scheduled during the candidate slot, verifying that there is no change of an active bandwidth after a triggering DCI is received, verifying that use of the candidate slot would not result in a change to a different active bandwidth part, verifying that a slot format indicator was not received after the plurality of indications was received, or a combination thereof. In some examples, the transmission of the SRS is scheduled as a time division duplex transmission on unpaired spectrum.

In some examples, determining the available slot may include at least one of verifying that a candidate slot indicated by the first indication is defined as an uplink slot or a flexible slot with sufficient time-domain and frequency-domain allocation for the transmission of the SRS, verifying that SRS transmission (e.g., the transmission of the SRS) does not collide with a higher priority uplink signal or uplink channel scheduled during the candidate slot, or a combination thereof. In some examples, the transmission of the SRS is scheduled as a frequency division duplex transmission on paired spectrum.

In some examples, the UE may receive a downlink control information (DCI) via a first frequency spectrum associated with a first subcarrier spacing, wherein the DCI schedules the transmission of the SRS on a second frequency spectrum associated with a second subcarrier spacing that is different from the first subcarrier spacing, map a first slot number of the DCI associated with the first subcarrier spacing to a second slot number associated with the second subcarrier spacing, identify a reference slot based on the second slot number and a slot offset, and identify an uplink slot for the transmission of the SRS based on the reference slot and the first indication. In some examples, the first indication is associated with the first subcarrier spacing, the UE may map the first indication to a second indication associated with the second subcarrier spacing, and identifying the uplink slot for the transmission of the SRS based on the second slot number and the first indication may include identifying the uplink slot for the transmission of the SRS based on the second slot number and the second indication. In some examples, the first frequency spectrum and the second frequency spectrum are allocated as paired spectrum for frequency division duplex communication.

In some examples, the UE may receive a downlink control information (DCI) via a first component carrier associated with a first subcarrier spacing, wherein the DCI schedules the transmission of the SRS on a second component carrier associated with a second subcarrier spacing that is different from the first subcarrier spacing, identify a reference slot based on a slot of the DCI and a slot offset associated with the second subcarrier spacing, and identify an uplink slot for the transmission of the SRS based on the reference slot and the first indication. In some examples, the slot offset is based on a time offset between the first component carrier and the second component carrier.

In some examples, selecting the first indication may include receiving a downlink control information (DCI) including a bit field, and selecting the first indication based on a value of the bit field, wherein the value of the bit field may include an absolute delay value. In some examples, the absolute delay value indicates a specific number of slots to delay the transmission of the SRS.

In some examples, the UE may receive downlink control information (DCI). In some examples, responsive to determining that a bit field of the DCI for the plurality of indications is disabled, the UE may select a delay value of zero for transmitting the SRS, select a default delay value for transmitting the SRS, select a radio resource control (RRC) configured delay value for transmitting the SRS, or select a first available slot for transmitting the SRS.

FIG. 16 is a flow chart illustrating an example wireless communication method 1600 in accordance with some aspects of the present disclosure. As described below, some or all illustrated features may be omitted in a particular implementation within the scope of the present disclosure, and some illustrated features may not be required for implementation of all examples. In some examples, the wireless communication method 1600 may be carried out by the UE 1400 illustrated in FIG. 14. In some examples, the wireless communication method 1600 may be carried out by any suitable apparatus or means for carrying out the functions or algorithm described below.

At block 1602, a UE may receive a downlink control information (DCI) including a bit field. For example, the SRS configuration circuitry 1442 together with the communication and processing circuitry 1441 and the transceiver 1410, shown and described above in connection with FIG. 14, may provide a means to receive a downlink control information (DCI) including a bit field.

At block 1604, the UE may identify a delay parameter based on a value of the bit field. For example, the SRS configuration circuitry 1442 may provide a means to identify a delay parameter based on a value of the bit field.

At block 1606, the UE may transmit a sounding reference signal (SRS) at a time that is based on the delay parameter. For example, the SRS processing circuitry 1443 together with the communication and processing circuitry 1441 and the transceiver 1410, shown and described above in connection with FIG. 14, may provide a means to transmit a sounding reference signal (SRS) at a time that is based on the delay parameter.

In some examples, the DCI may include a data scheduling DCI format 0_1, a DCI format 0_1, a DCI format 0_2, a DCI format 1_1, or a DCI format 1_2. In some examples, the bit field is a single bit.

In some examples, the UE may receive a data set that maps a first value of the bit field to a first delay value for the transmission (transmitting) of the SRS, and a second value of the bit field to a second delay value for the transmission of the SRS.

In some examples, the UE may receive a data set that maps a first value of the bit field to a first delay value for the transmission of the SRS, and a second value of the bit field to an indication to use a first available slot for the transmission of the SRS.

In some examples, the bit field is dedicated for indicating which of a plurality of delay values is to be used for the transmission of the SRS.

In some examples, the bit field is reallocated for indicating which of a plurality of delay values is to be used for the transmission of the SRS. In some examples, the bit field is a reallocated SRS trigger field or a time domain resource allocation (TDRA) field.

In some examples, the UE may receive a message specifying that the value of the bit field applies to all of a plurality of SRS resource sets defined for a bandwidth part. In some examples, the message may include a radio resource control (RRC) configuration.

In some examples, the UE may receive a message specifying that the value of the bit field applies to a subset of a plurality of SRS resource sets defined for a bandwidth part. In some examples, the UE may receive a data set that maps a first value for the bit field to a first delay value for a first SRS resource set of the plurality of SRS resource sets, the first value for the bit field to a second delay value for a second SRS resource set of the plurality of SRS resource sets, a second value for the bit field to a third delay value for the first SRS resource set of the plurality of SRS resource sets, and the second value for the bit field to a fourth delay value for the second SRS resource set of the plurality of SRS resource sets.

In some examples, the DCI triggers the transmission of the SRS and does not schedule a data transmission. In some examples, the bit field is a plurality of bits.

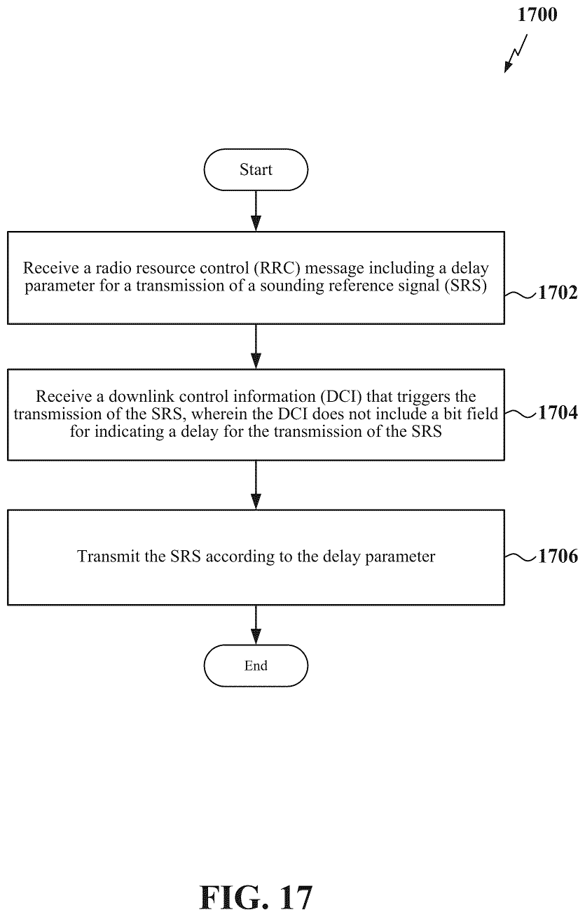

FIG. 17 is a flow chart illustrating an example wireless communication method 1700 in accordance with some aspects of the present disclosure. As described below, some or all illustrated features may be omitted in a particular implementation within the scope of the present disclosure, and some illustrated features may not be required for implementation of all examples. In some examples, the wireless communication method 1700 may be carried out by the UE 1400 illustrated in FIG. 14. In some examples, the wireless communication method 1700 may be carried out by any suitable apparatus or means for carrying out the functions or algorithm described below.

At block 1702, a UE may receive a radio resource control (RRC) message including a delay parameter for a transmission of a sounding reference signal (SRS). For example, the SRS configuration circuitry 1442 together with the communication and processing circuitry 1441 and the transceiver 1410, shown and described above in connection with FIG. 14, may provide a means to receive a radio resource control (RRC) message including a delay parameter for a transmission of a sounding reference signal (SRS).

At block 1704, the UE may receive a downlink control information (DCI) that triggers the transmission of the SRS, wherein the DCI does not include a bit field for indicating a delay for the transmission of the SRS. For example, the SRS configuration circuitry 1442 together with the communication and processing circuitry 1441 and the transceiver 1410, shown and described above in connection with FIG. 14, may provide a means to receive a downlink control information (DCI) that triggers the transmission of the SRS.

At block 1706, the UE may transmit the SRS according to the delay parameter. For example, the SRS processing circuitry 1443 together with the communication and processing circuitry 1441 and the transceiver 1410, shown and described above in connection with FIG. 14, may provide a means to transmit the SRS according to the delay parameter.

In some examples, the delay parameter specifies a delay value for the transmission of the SRS, and the transmitting the SRS according to the delay parameter may include transmitting the SRS according to the delay value.

In some examples, the delay parameter specifies that the user equipment is to use a first available slot to transmit the SRS, and the transmitting the SRS according to the delay parameter may include transmitting the SRS during the first available slot.

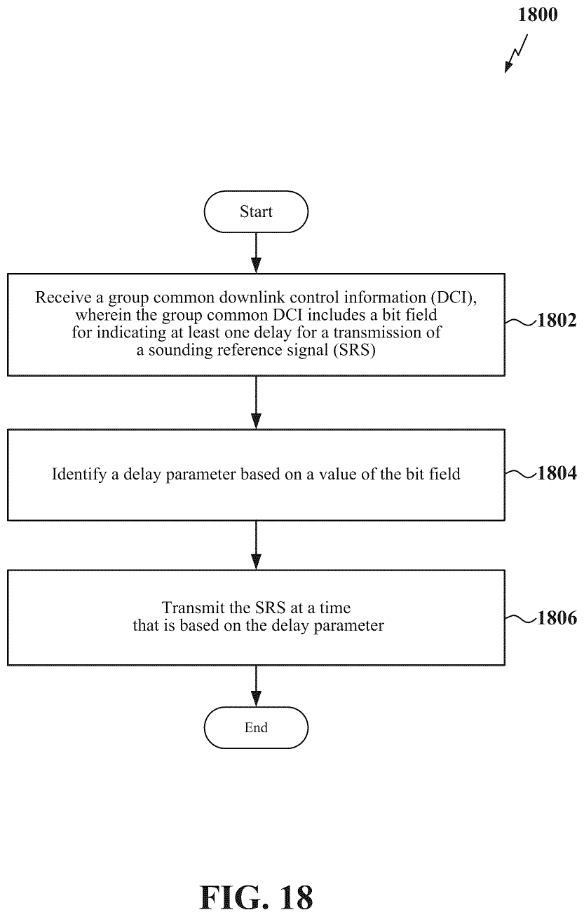

FIG. 18 is a flow chart illustrating an example wireless communication method 1800 in accordance with some aspects of the present disclosure. As described below, some or all illustrated features may be omitted in a particular implementation within the scope of the present disclosure, and some illustrated features may not be required for implementation of all examples. In some examples, the wireless communication method 1800 may be carried out by the UE 1400 illustrated in FIG. 14. In some examples, the wireless communication method 1800 may be carried out by any suitable apparatus or means for carrying out the functions or algorithm described below.

At block 1802, a UE may receive a group common downlink control information (DCI), wherein the group common DCI includes a bit field for indicating at least one delay for a transmission of a sounding reference signal (SRS). For example, the SRS configuration circuitry 1442 together with the communication and processing circuitry 1441 and the transceiver 1410, shown and described above in connection with FIG. 14, may provide a means to receive a group common downlink control information (DCI).

At block 1804, the UE may identify a delay parameter based on a value of the bit field. For example, the SRS configuration circuitry 1442 may provide a means to identify a delay parameter based on a value of the bit field.

At block 1806, the UE may transmit the SRS at a time that is based on the delay parameter. For example, the SRS processing circuitry 1443 together with the communication and processing circuitry 1441 and the transceiver 1410, shown and described above in connection with FIG. 14, may provide a means to transmit the SRS at a time that is based on the delay parameter.

In some examples, the group common DCI is a format 2_3 DCI, and the group common DCI may include a component carrier block that includes the bit field. In some examples, the group common DCI is a format 2_3 DCI, and the group common DCI may include a payload that includes the bit field, and the bit field may include a plurality of bits that are mapped to a plurality of component carriers scheduled by the group common DCI.

In some examples, the UE may receive a radio resource control (RRC) message including a pointer that maps a first bit of the bit field to at least a first component carrier of the plurality of component carriers, and a second bit of the bit field to at least a second component carrier of the plurality of component carriers.

In some examples, the UE may receive a radio resource control (RRC) message specifying that the bit field applies to all of a plurality of SRS resource sets defined for a bandwidth part. In some examples, the UE may receive a radio resource control (RRC) message specifying that the bit field applies to a subset of a plurality of SRS resource sets defined for a bandwidth part.

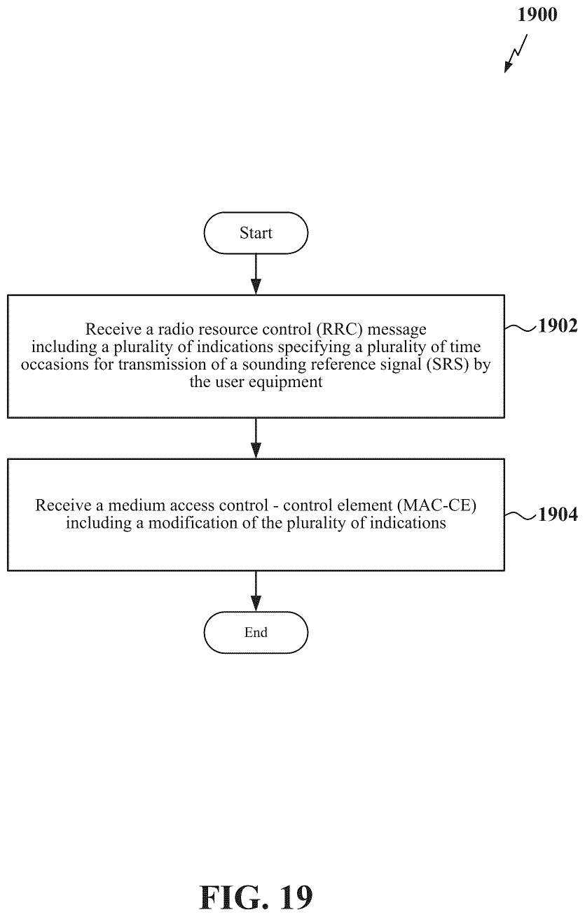

FIG. 19 is a flow chart illustrating an example wireless communication method 1900 in accordance with some aspects of the present disclosure. As described below, some or all illustrated features may be omitted in a particular implementation within the scope of the present disclosure, and some illustrated features may not be required for implementation of all examples. In some examples, the wireless communication method 1900 may be carried out by the UE 1400 illustrated in FIG. 14. In some examples, the wireless communication method 1900 may be carried out by any suitable apparatus or means for carrying out the functions or algorithm described below.

At block 1902, a UE may receive a radio resource control (RRC) message including a plurality of indications specifying a plurality of time occasions for transmission of a sounding reference signal (SRS) by the user equipment. For example, the SRS configuration circuitry 1442 together with the communication and processing circuitry 1441 and the transceiver 1410, shown and described above in connection with FIG. 14, may provide a means to receive a radio resource control (RRC) message including a plurality of indications specifying a plurality of time occasions for transmission of a sounding reference signal (SRS) by the user equipment.

At block 1904, the UE may receive a medium access control-control element (MAC-CE) including a modification of the plurality of indications. For example, the SRS configuration circuitry 1442 together with the communication and processing circuitry 1441 and the transceiver 1410, shown and described above in connection with FIG. 14, may provide a means to receive a medium access control-control element (MAC-CE) including a modification of the plurality of indications.

In some examples, the modification of the plurality of indications may include an update of at least one of the plurality of indications, an addition of at least one indication to the plurality of indications, or a deletion of at least one of the plurality of indications.

In some examples, the modification of the plurality of indications may include modification of the plurality of indications for all SRS resource sets for each bandwidth part of each serving cell of a base station.

In some examples, the modification of the plurality of indications may include modification of the plurality of indications for all SRS resource sets for a plurality of component carriers.

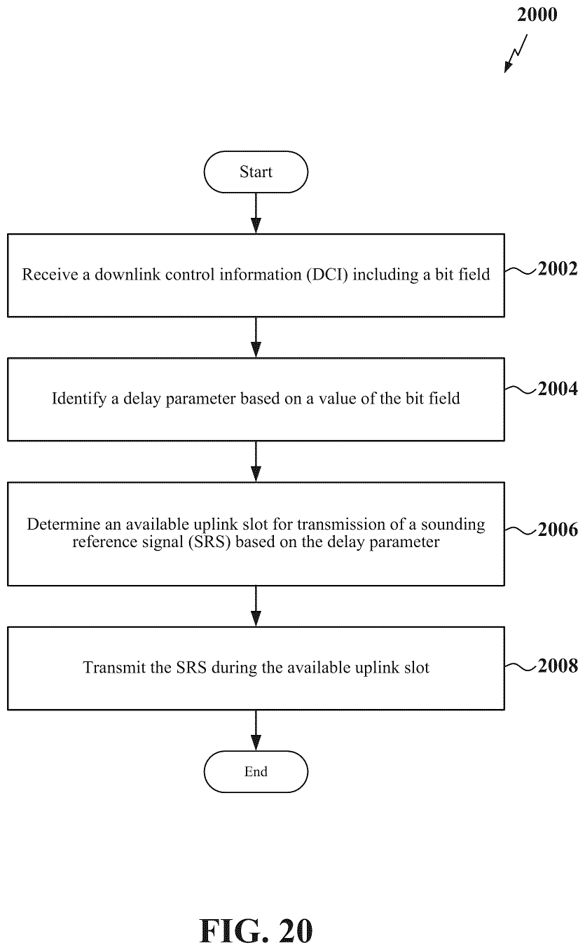

FIG. 20 is a flow chart illustrating an example wireless communication method 2000 in accordance with some aspects of the present disclosure. As described below, some or all illustrated features may be omitted in a particular implementation within the scope of the present disclosure, and some illustrated features may not be required for implementation of all examples. In some examples, the wireless communication method 2000 may be carried out by the UE 1400 illustrated in FIG. 14. In some examples, the wireless communication method 2000 may be carried out by any suitable apparatus or means for carrying out the functions or algorithm described below.

At block 2002, a UE may receive a downlink control information (DCI) including a bit field. For example, the SRS configuration circuitry 1442 together with the communication and processing circuitry 1441 and the transceiver 1410, shown and described above in connection with FIG. 14, may provide a means to receive a downlink control information (DCI) including a bit field

At block 2004, the UE may identify a delay parameter based on a value of the bit field. For example, the SRS configuration circuitry 1442 may provide a means to identify a delay parameter based on a value of the bit field.

At block 2006, the UE may determine an available slot for transmission of a sounding reference signal (SRS) based on the delay parameter. For example, the SRS configuration circuitry 1442 may provide a means to determine an available slot for transmission of a sounding reference signal (SRS) based on the delay parameter.

At block 2008, the UE may transmit the SRS during the available slot. For example, the SRS processing circuitry 1443 together with the communication and processing circuitry 1441 and the transceiver 1410, shown and described above in connection with FIG. 14, may provide a means to transmit the SRS during the available slot.

In some examples, determining the available slot may include at least one of verifying that a candidate slot indicated by the delay parameter is defined as an uplink slot, a special slot, or a flexible slot with sufficient time-domain and frequency-domain allocation for the transmission of the SRS, verifying that SRS transmission (e.g., the transmission of the SRS) does not collide with a higher priority uplink signal or uplink channel scheduled during the candidate slot, verifying that there is no change of an active bandwidth after a triggering DCI is received, verifying that use of the candidate slot would not result in a change to a different active bandwidth part, verifying that a slot format indicator was not received after an SRS allocation for the transmission of the SRS was received, or a combination thereof. In some examples, the transmission of the SRS is scheduled as a time division duplex transmission on unpaired spectrum.

In some examples, determining the available slot may include at least one of verifying that a candidate slot indicated by the bit field is defined as an uplink slot or a flexible slot with sufficient time-domain and frequency-domain allocation for the transmission of the SRS, verifying that SRS transmission (e.g., the transmission of the SRS) does not collide with a higher priority uplink signal or uplink channel scheduled during the candidate slot, or a combination thereof. In some examples, the transmission of the SRS is scheduled as a frequency division duplex transmission on paired spectrum.

FIG. 21 is a flow chart illustrating an example wireless communication method 2100 in accordance with some aspects of the present disclosure. As described below, some or all illustrated features may be omitted in a particular implementation within the scope of the present disclosure, and some illustrated features may not be required for implementation of all examples. In some examples, the wireless communication method 2100 may be carried out by the UE 1400 illustrated in FIG. 14. In some examples, the wireless communication method 2100 may be carried out by any suitable apparatus or means for carrying out the functions or algorithm described below.

At block 2102, a UE may receive a downlink control information (DCI) via a first frequency spectrum associated with a first subcarrier spacing, wherein the DCI schedules a transmission of a sounding reference signal (SRS) on a second frequency spectrum associated with a second subcarrier spacing that is different from the first subcarrier spacing. For example, the SRS configuration circuitry 1442 together with the communication and processing circuitry 1441 and the transceiver 1410, shown and described above in connection with FIG. 14, may provide a means to receive a downlink control information (DCI) via a first frequency spectrum associated with a first subcarrier spacing.

At block 2104, the UE may map a first slot number of the DCI associated with the first subcarrier spacing to a second slot number associated with the first subcarrier spacing. For example, the SRS configuration circuitry 1442, shown and described above in connection with FIG. 14, may provide a means to map a first slot number of the DCI associated with the first subcarrier spacing to a second slot number associated with the first subcarrier spacing.

At block 2106, the UE may identify an uplink slot for the transmission of the SRS based on the second slot number and a first indication of a delay value for the transmission of the SRS. For example, the SRS configuration circuitry 1442, shown and described above in connection with FIG. 14, may provide a means to identify an uplink slot for the transmission of the SRS based on the second slot number and a first indication of a delay value for the transmission of the SRS.

In some examples, the first indication is associated with the first subcarrier spacing, the UE may map the first indication to a second indication associated with the second subcarrier spacing, and identifying the uplink slot for the transmission of the SRS based on the second slot number and the first indication may include identifying the uplink slot for the transmission of the SRS based on the second slot number and the second indication.

In some examples, the first frequency spectrum and the second frequency spectrum are allocated as paired spectrum for frequency division duplex communication. In some examples, the first indication specifies an available slot relative to a reference slot.

FIG. 22 is a flow chart illustrating an example wireless communication method 2200 in accordance with some aspects of the present disclosure. As described below, some or all illustrated features may be omitted in a particular implementation within the scope of the present disclosure, and some illustrated features may not be required for implementation of all examples. In some examples, the wireless communication method 2200 may be carried out by the UE 1400 illustrated in FIG. 14. In some examples, the wireless communication method 2200 may be carried out by any suitable apparatus or means for carrying out the functions or algorithm described below.

At block 2202, a UE may receive a downlink control information (DCI) via a first component carrier associated with a first subcarrier spacing, wherein the DCI schedules a transmission of a sounding reference signal (SRS) on a second component carrier associated with a second subcarrier spacing that is different from the first subcarrier spacing. For example, the SRS configuration circuitry 1442 together with the communication and processing circuitry 1441 and the transceiver 1410, shown and described above in connection with FIG. 14, may provide a means to receive a downlink control information (DCI) via a first component carrier associated with a first subcarrier spacing.

At block 2204, the UE may identify a reference slot based on a slot of the DCI and a slot offset associated with the second subcarrier spacing. For example, the SRS configuration circuitry 1442, shown and described above in connection with FIG. 14, may provide a means to identify a reference slot based on a slot of the DCI and a slot offset associated with the second subcarrier spacing.

At block 2206, the UE may identify an uplink slot for the transmission of the SRS based on the reference slot and a first indication of a delay value for the transmission of the SRS. For example, the SRS configuration circuitry 1442, shown and described above in connection with FIG. 14, may provide a means to identify an uplink slot for the transmission of the SRS based on the reference slot and a first indication of a delay value for the transmission of the SRS. In some examples, the slot offset is based on a time offset between the first component carrier and the second component carrier.

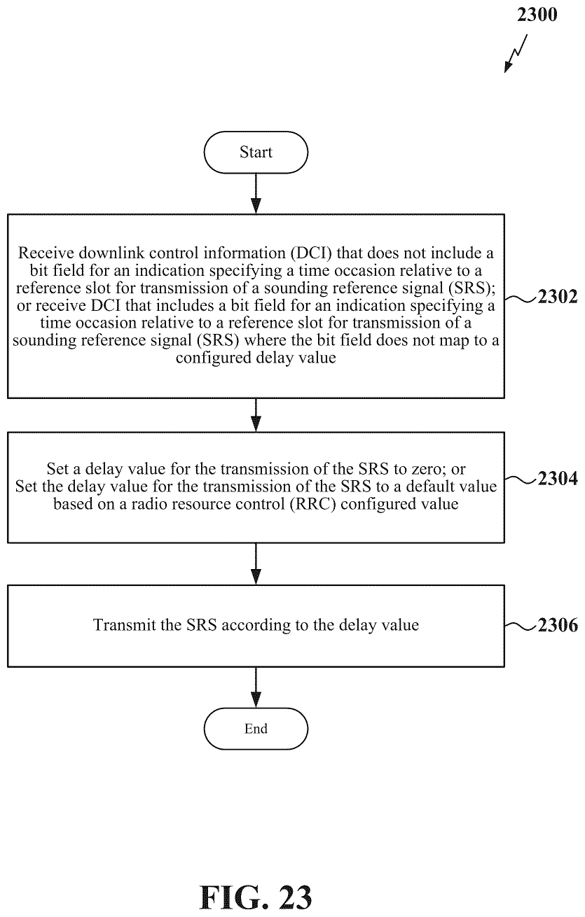

FIG. 23 is a flow chart illustrating an example wireless communication method 2300 in accordance with some aspects of the present disclosure. As described below, some or all illustrated features may be omitted in a particular implementation within the scope of the present disclosure, and some illustrated features may not be required for implementation of all examples. In some examples, the wireless communication method 2300 may be carried out by the UE 1400 illustrated in FIG. 14. In some examples, the wireless communication method 2300 may be carried out by any suitable apparatus or means for carrying out the functions or algorithm described below.

At block 2302, a UE may receive downlink control information (DCI) that does not include a bit field for an indication specifying a time occasion relative to a reference slot for transmission of a sounding reference signal (SRS); or receive DCI that includes a bit field for an indication specifying a time occasion relative to a reference slot for transmission of a sounding reference signal (SRS) where the bit field does not map to a configured delay value. For example, the SRS configuration circuitry 1442 together with the communication and processing circuitry 1441 and the transceiver 1410, shown and described above in connection with FIG. 14, may provide a means to receive downlink control information (DCI) that does not include a bit field for an indication specifying a time occasion relative to a reference slot for transmission of a sounding reference signal (SRS); or receive DCI that includes a bit field for an indication specifying a time occasion relative to a reference slot for transmission of a sounding reference signal (SRS) where the bit field does not map to a configured delay value.

At block 2304, the UE may set a delay value for the transmission of the SRS to zero; or set the delay value for the transmission of the SRS to a default value based on a radio resource control (RRC) configured value. For example, the SRS configuration circuitry 1442, shown and described above in connection with FIG. 14, may provide a means to set a delay value for the transmission of the SRS to zero; or set the delay value for the transmission of the SRS to a default value based on a radio resource control (RRC) configured value.

At block 2306, the UE may transmit the SRS according to the delay value. For example, the SRS processing circuitry 1443 together with the communication and processing circuitry 1441 and the transceiver 1410, shown and described above in connection with FIG. 14, may provide a means to transmit the SRS according to the delay value.

In some examples, a method for wireless communication at a user equipment may include receiving a downlink control information (DCI) that includes a bit field, identifying a delay parameter based on a value of the bit field, and transmitting a sounding reference signal (SRS) at a time that is based on the delay parameter.

In some examples, a user equipment may include a transceiver, a memory, and a processor communicatively coupled to the transceiver and the memory. The processor and the memory may be configured to receive via the transceiver a downlink control information (DCI) comprising a bit field, identify a delay parameter based on a value of the bit field, and transmit a sounding reference signal (SRS) via the transceiver at a time that is based on the delay parameter.

In some examples, a user equipment may include means for receiving a downlink control information (DCI) comprising a bit field, means for identifying a delay parameter based on a value of the bit field, and means for transmitting a sounding reference signal (SRS) at a time that is based on the delay parameter.

In some examples, an article of manufacture for use by a user equipment includes a computer-readable medium having stored therein instructions executable by one or more processors of the user equipment to receive a downlink control information (DCI) comprising a bit field, identify a delay parameter based on a value of the bit field, and transmit a sounding reference signal (SRS) at a time that is based on the delay parameter.

One or more of the following features may be applicable to one or more of the method, the apparatuses, and the computer-readable medium of the preceding paragraphs. The DCI may include a data scheduling DCI format 0_1, a DCI format 0_1, a DCI format 0_2, a DCI format 1_1, or a DCI format 1_2. The bit field may be a single bit. A received data set may map a first value of the bit field to a first delay value for the transmission of the SRS and a second value of the bit field to a second delay value for the transmission of the SRS. A received data set may map a first value of the bit field to a first delay value for the transmission of the SRS and a second value of the bit field to an indication to use a first available slot for the transmission of the SRS.

In one configuration, the user equipment 1400 includes means for receiving a plurality of indications specifying a plurality of time occasions relative to a reference slot for transmission of a sounding reference signal (SRS) by the user equipment, means for selecting a first indication of the plurality of indications, and means for transmitting the SRS at a time that is based on the first indication. In one aspect, the aforementioned means may be the processor 1404 shown in FIG. 14 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1404 is merely provided as an example, and other means for carrying out the described functions may be included within various aspects of the present disclosure, including but not limited to the instructions stored in the computer-readable medium 1406, or any other suitable apparatus or means described in any one or more of FIGS. 1, 2, 4, 5, and 14, and utilizing, for example, the methods and/or algorithms described herein in relation to FIGS. 15-23.

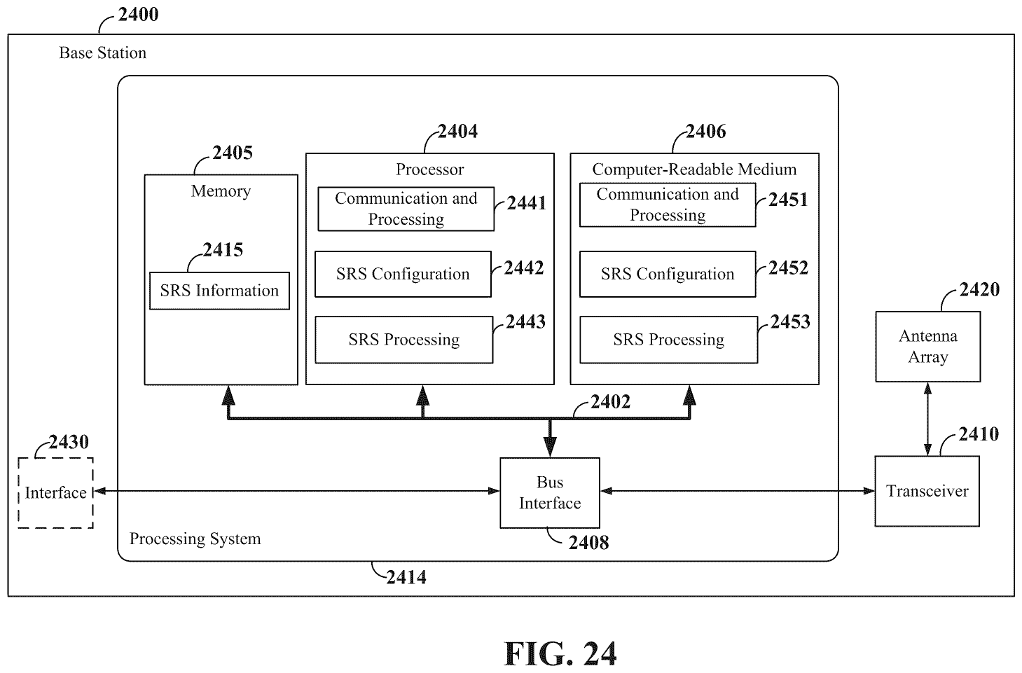

FIG. 24 is a conceptual diagram illustrating an example of a hardware implementation for base station (BS) 2400 employing a processing system 2414. In some implementations, the BS 2400 may correspond to any of the BSs (e.g., gNBs) or scheduling entities shown in any of FIGS. 1, 2, 4, and 5.

In accordance with various aspects of the disclosure, an element, or any portion of an element, or any combination of elements may be implemented with the processing system 2414. The processing system may include one or more processors 2404. The processing system 2414 may be substantially the same as the processing system 1414 illustrated in FIG. 14, including a bus interface 2408, a bus 2402, memory 2405, a processor 2404, and a computer-readable medium 2406. The memory 2405 may store SRS information 2415 (e.g., SRS time occasion parameters) used by the processor 2404 in cooperation with the transceiver 2410 for configuring and receiving SRS transmissions. Furthermore, the BS 2400 may include an interface 2430 (e.g., a network interface) that provides a means for communicating with at least one other apparatus within a core network and with at least one radio access network.

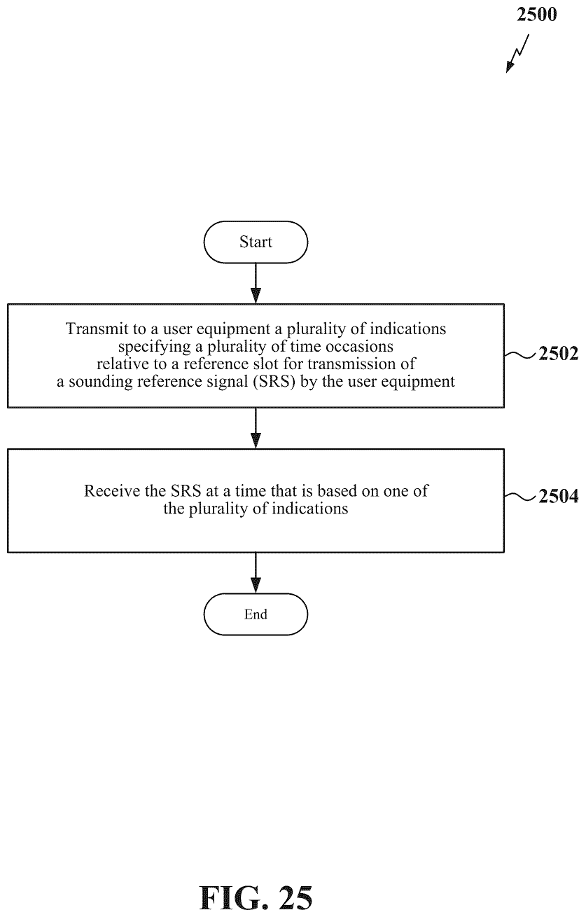

The BS 2400 may be configured to perform any one or more of the operations described herein (e.g., as described above in conjunction with FIGS. 1-13 and as described below in conjunction with FIGS. 25-31). In some aspects of the disclosure, the processor 2404, as utilized in the BS 2400, may include circuitry configured for various functions.

The processor 2404 may be configured to generate, schedule, and modify a resource assignment or grant of time-frequency resources (e.g., a set of one or more resource elements). For example, the processor 2404 may schedule time-frequency resources within a plurality of time division duplex (TDD) and/or frequency division duplex (FDD) subframes, slots, and/or mini-slots to carry user data traffic and/or control information to and/or from multiple UEs.

In some aspects of the disclosure, the processor 2404 may include communication and processing circuitry 2441. The communication and processing circuitry 2444 may be configured to communicate with a UE. The communication and processing circuitry 2441 may include one or more hardware components that provide the physical structure that performs various processes related to communication (e.g., signal reception and/or signal transmission) as described herein. The communication and processing circuitry 2441 may further include one or more hardware components that provide the physical structure that performs various processes related to signal processing (e.g., processing a received signal and/or processing a signal for transmission) as described herein. The communication and processing circuitry 2441 may further be configured to execute communication and processing software 2451 included on the computer-readable medium 2406 to implement one or more functions described herein.

The communication and processing circuitry 2441 may further be configured to receive a request from the UE. For example, the request may be included in a MAC-CE carried in a PUSCH, UCI in a PUCCH or PUSCH, a random access message, or an RRC message. The communication and processing circuitry 2441 may further be configured to receive a scheduling request (e.g., via UCI in a PUCCH) from the UE for an uplink grant for the PUSCH.

In some implementations wherein the communication involves receiving information, the communication and processing circuitry 2441 may obtain information from a component of the BS 2400 (e.g., from the transceiver 2410 that receives the information via radio frequency signaling or some other type of signaling suitable for the applicable communication medium), process (e.g., decode) the information, and output the processed information. For example, the communication and processing circuitry 2441 may output the information to another component of the processor 2404, to the memory 2405, or to the bus interface 2408. In some examples, the communication and processing circuitry 2441 may receive one or more of signals, messages, other information, or any combination thereof. In some examples, the communication and processing circuitry 2441 may receive information via one or more channels. In some examples, the communication and processing circuitry 2441 may include functionality for a means for receiving. In some examples, the communication and processing circuitry 2441 may include functionality for a means for decoding.

In some implementations wherein the communication involves sending (e.g., transmitting) information, the communication and processing circuitry 2441 may obtain information (e.g., from another component of the processor 2404, the memory 2405, or the bus interface 2408), process (e.g., encode) the information, and output the processed information. For example, the communication and processing circuitry 2441 may output the information to the transceiver 2410 (e.g., that transmits the information via radio frequency signaling or some other type of signaling suitable for the applicable communication medium). In some examples, the communication and processing circuitry 2441 may send one or more of signals, messages, other information, or any combination thereof. In some examples, the communication and processing circuitry 2441 may send information via one or more channels. In some examples, the communication and processing circuitry 2441 may include functionality for a means for sending (e.g., a means for transmitting). In some examples, the communication and processing circuitry 2441 may include functionality for a means for encoding.

The processor 2404 may include SRS configuration circuitry 2442 configured to perform SRS configuration-related operations as discussed herein (e.g., one or more of the operations described in conjunction with FIGS. 8-13). The SRS configuration circuitry 2442 may be configured to execute SRS configuration software 2452 included on the computer-readable medium 2406 to implement one or more functions described herein.

The SRS configuration circuitry 2442 may include functionality for a means for determining indications (e.g., as described at FIGS. 8-11, and/or at block 2502 of FIG. 25). For example, the SRS configuration circuitry 2442 may determine that a UE is to use a particular set of delay parameters (e.g., a table including K1 and K2 or other parameters) based on, for example, the SRS configuration (e.g., narrowband or wideband SRS, frequency hopping, etc.). In some examples, the SRS configuration circuitry 2442 may determine that a UE is to transmit its SRS as soon as possible and therefore select a shorter delay parameter of a set of delay parameters (e.g., a table including K1 and K2 or other parameters).

The SRS configuration circuitry 2442 may include functionality for a means for transmitting indications (e.g., as described at FIGS. 8-11, and/or at block 2504 of FIG. 25). For example, the SRS configuration circuitry 2442 together with the communication and processing circuitry 2441 and the transceiver 2410 may transmit an RRC message that includes SRS configuration information to a UE on a downlink channel (e.g., PDSCH).

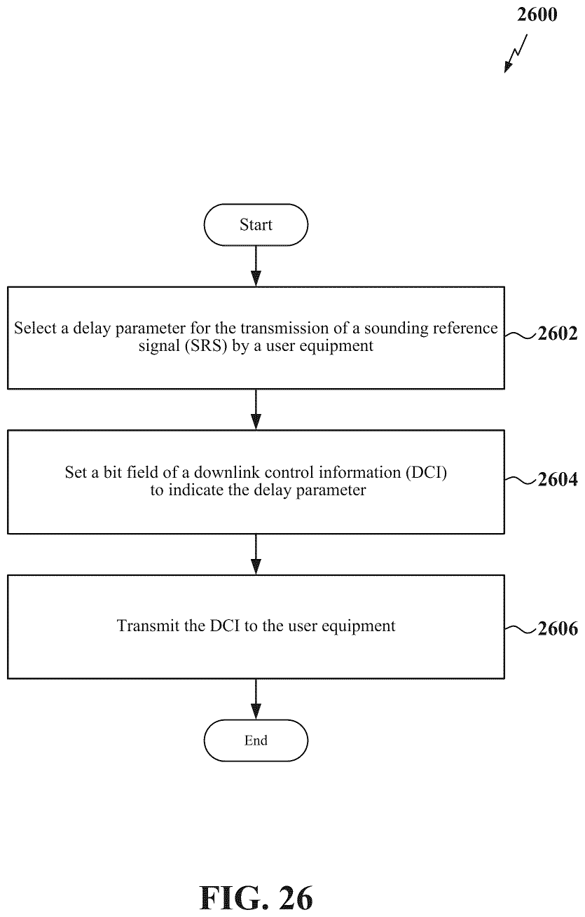

The SRS configuration circuitry 2442 may include functionality for a means for selecting a delay parameter (e.g., as described at FIGS. 11-13, and/or at block 2602 of FIG. 26). The SRS configuration circuitry 2442 may include functionality for a means for setting a bit field (e.g., as described at FIGS. 11-13, and/or at block 2604 of FIG. 26). For example, the SRS configuration circuitry 2442 may generate a DCI that triggers an SRS and includes a bit field for specifying an SRS delay for a UE.

The SRS configuration circuitry 2442 may include functionality for a means for transmitting a DCI (e.g., as described at FIGS. 5-8, 13, and 24 and/or at block 2606 of FIG. 26). For example, the SRS configuration circuitry 2442 together with the communication and processing circuitry 2441 and the transceiver 2410 may transmit a DCI that triggers an SRS transmission by a UE on a designated downlink channel (e.g., PDCCH).

The processor 2404 may include SRS processing circuitry 2443 configured to perform SRS processing-related operations as discussed herein (e.g., one or more of the operations described in conjunction with FIGS. 8-13). The SRS processing circuitry 2443 may be configured to execute SRS processing software 2453 included on the computer-readable medium 2406 to implement one or more functions described herein.

The SRS processing circuitry 2443 may include functionality for a means for receiving SRS (e.g., as described at FIGS. 5-8, 13, and 24 and/or at block 2506 of FIG. 25). For example, the SRS processing circuitry 2443 together with the communication and processing circuitry 2441 and the transceiver 2410 may receive an SRS on a designated SRS resource set during a slot indicated by K1, K2, or some other indication.

The SRS processing circuitry 2443 may include functionality for a means for transmitting a DCI (e.g., as described at FIGS. 5-8, 13, and 24 and/or at block 2606 of FIG. 26). For example, the SRS processing circuitry 2443 together with the communication and processing circuitry 2441 and the transceiver 2410 may transmit a DCI that triggers an SRS transmission by a UE on a designated downlink channel (e.g., PDCCH).

FIG. 25 is a flow chart illustrating an example wireless communication method 2500 according to some aspects of the disclosure. As described herein, some or all illustrated features may be omitted in a particular implementation within the scope of the present disclosure, and some illustrated features may not be required for implementation of all examples. In some examples, the wireless communication method 2500 may be carried out by the BS 2400 illustrated in FIG. 24. In some examples, the wireless communication method 2500 may be carried out by any suitable apparatus or means for carrying out the functions or algorithm described below.

At block 2502, the base station may transmit to a user equipment a plurality of indications specifying a plurality of time occasions relative to a reference slot for transmission of a sounding reference signal (SRS) by the user equipment. For example, the SRS configuration circuitry 2442 together with the communication and processing circuitry 2441 and the transceiver 2410, shown and described above in connection with FIG. 24, may provide a means to transmit to a user equipment a plurality of indications specifying a plurality of time occasions relative to a reference slot for transmission of a sounding reference signal (SRS) by the user equipment.

At block 2504, the base station may receive the SRS at a time that is based on one of the plurality of indications. For example, the SRS processing circuitry 2443 together with the communication and processing circuitry 2441 and the transceiver 2410, shown and described above in connection with FIG. 24, may provide a means to receive the SRS at a time that is based on one of the plurality of indications.

In some examples, the plurality of indications may include a first delay value, and a second delay value. In some examples, the first delay value may include a second indication to a first available slot. In some examples, the second delay value may include a third indication to a second available slot that is different from the first available slot.

In some examples, the plurality of indications may include a first delay value, and an indication to use a first available slot. In some examples, the indication to use the first available slot may include a value of zero.

In some examples, the base station may determine the plurality of indications. In some examples, determining the plurality of indications may include selecting the plurality of indications based on a sub-carrier spacing to be used by the user equipment for the transmission of the SRS.

In some examples, determining the plurality of indications may include selecting the plurality of indications based on a sub-carrier spacing of a bandwidth part to be used by the user equipment for the transmission of the SRS.

In some examples, the plurality of indications are for a specified SRS resource set. In some examples, a time domain behavior of the SRS resource set is aperiodic.

In some examples, transmitting the plurality of indications may include transmitting a radio resource control (RRC) configuration including a first field and a second field for the plurality of indications.

In some examples, the plurality of indications may include a first field that includes a first delay value, and a second field that includes a second delay value and a third delay value. In some examples, the first delay value may include a first indication to a first available slot, the second delay value may include a second indication to a second available slot that is different from the first available slot, and the third delay value may include a third indication to a third available slot that is different from the second available slot.

In some examples, the plurality of indications may include a first field that includes a first delay value, and a second field that includes a second delay value and an indication to use a first available slot. In some examples, the indication to use the first available slot may include a value of zero.

In some examples, the base station may select a delay parameter for the transmission of the SRS by the user equipment, set a bit field of a downlink control information (DCI) to indicate the delay parameter, and transmit the DCI to the user equipment. In some examples, the base station may transmit a radio resource control (RRC) message specifying that the bit field applies to all of a plurality of SRS resource sets defined for a bandwidth part.

In some examples, the base station may transmit a radio resource control (RRC) message specifying that the bit field applies to a subset of a plurality of SRS resource sets defined for a bandwidth part. In some examples, the plurality of indications map a first value for the bit field to a first delay value for a first SRS resource set of the plurality of SRS resource sets, the first value for the bit field to a second delay value for a second SRS resource set of the plurality of SRS resource sets, a second value for the bit field to a third delay value for the first SRS resource set of the plurality of SRS resource sets, and the second value for the bit field to a fourth delay value for the second SRS resource set of the plurality of SRS resource sets.

In some examples, the base station may determine that the user equipment is not to delay the transmission of the SRS, and transmit a downlink control information (DCI) to the user equipment to trigger the transmission of the SRS, wherein the DCI does not include a bit field for indicating a delay value for the transmission of the SRS.

In some examples, the base station may select a delay value for the transmission of the SRS by the user equipment, transmit a radio resource control (RRC) message specifying the delay value to the user equipment, and transmit a downlink control information (DCI) to the user equipment to trigger the transmission of the SRS, wherein the DCI does not include a bit field for indicating the delay value.

In some examples, the base station may transmit a radio resource control (RRC) message including an indication that the user equipment is to use a first available slot to transmit the SRS, and transmit a downlink control information (DCI) to the user equipment to trigger the transmission of the SRS, wherein the DCI does not include a bit field for indicating a delay value for the transmission of the SRS.

In some examples, the base station may select a delay value for the transmission of the SRS by the user equipment, set a bit field of a group common downlink control information (DCI) to indicate the delay value, and transmit the DCI to the user equipment.

In some examples, the group common DCI is a format 2_3 DCI, and the group common DCI may include a component carrier block that includes the bit field. In some examples, the group common DCI is a format 2_3 DCI, and the group common DCI may include a payload that includes the bit field, and the bit field may include a plurality of bits that are mapped to a plurality of component carriers scheduled by the group common DCI.

In some examples, the base station may transmit a radio resource control (RRC) message including a pointer that maps a first bit of the bit field to at least a first component carrier of the plurality of component carriers, and a second bit of the bit field to at least a second component carrier of the plurality of component carriers.

In some examples, the base station may transmit a radio resource control (RRC) message specifying that the bit field applies to all of a plurality of SRS resource sets defined for a bandwidth part. In some examples, the base station may transmit a radio resource control (RRC) message specifying that the bit field applies to a subset of a plurality of SRS resource sets defined for a bandwidth part.

In some examples, the base station may determine a modification of the plurality of indications, and transmit a medium access control-control element (MAC-CE) including the modification of the plurality of indications. In some examples, the modification of the plurality of indications may include an update of at least one of the plurality of indications, an addition of at least one indication to the plurality of indications, or a deletion of at least one of the plurality of indications. In some examples, the modification of the plurality of indications may include modification of the plurality of indications for all SRS resource sets for each bandwidth part of each serving cell of the base station. In some examples, the modification of the plurality of indications may include modification of the plurality of indications for all SRS resource sets for a plurality of component carriers.

In some examples, the base station may transmit a downlink control information (DCI) via a first frequency spectrum associated with a first subcarrier spacing, wherein the DCI schedules the transmission of the SRS on a second frequency spectrum associated with a second subcarrier spacing that is different from the first subcarrier spacing, wherein the DCI may include a bit field for an indication of a delay value for the transmission of the SRS.

In some examples, the base station may transmit a downlink control information (DCI) via a first component carrier associated with a first subcarrier spacing, wherein the DCI schedules the transmission of the SRS on a second component carrier associated with a second subcarrier spacing that is different from the first subcarrier spacing, wherein the DCI may include a bit field for an indication of a delay value for the transmission of the SRS.

In some examples, the base station may determine an absolute delay value for delaying the transmission of the SRS, and transmit a downlink control information (DCI) including the absolute delay value. In some examples, the absolute delay value indicates a specific number of slots to delay the transmission of the SRS.

FIG. 26 is a flow chart illustrating an example wireless communication method 2600 according to some aspects of the disclosure. As described herein, some or all illustrated features may be omitted in a particular implementation within the scope of the present disclosure, and some illustrated features may not be required for implementation of all examples. In some examples, the wireless communication method 2600 may be carried out by the BS 2400 illustrated in FIG. 24. In some examples, the wireless communication method 2600 may be carried out by any suitable apparatus or means for carrying out the functions or algorithm described below.

At block 2602, a base station may select a delay parameter for a transmission of a sounding reference signal (SRS) by a user equipment. For example, the SRS configuration circuitry 2442, shown and described above in connection with FIG. 24, may provide a means to select a delay parameter for a transmission of a sounding reference signal (SRS) by a user equipment.

At block 2604, the base station may set a bit field of a downlink control information (DCI) to indicate the delay parameter. For example, the SRS configuration circuitry 2442, shown and described above in connection with FIG. 24, may provide a means to set a bit field of a downlink control information (DCI) to indicate the delay parameter.

At block 2606, the base station may transmit the DCI to the user equipment. For example, the SRS processing circuitry 2443 together with the communication and processing circuitry 2441 and the transceiver 2410, shown and described above in connection with FIG. 24, may provide a means to transmit the DCI to the user equipment.

In some examples, the DCI may include a data scheduling DCI format 0_1, a DCI format 0_1, a DCI format 0_2, a DCI format 1_1, or a DCI format 1_2, and the bit field is a single bit.

In some examples, the base station may transmit to the user equipment a data set that maps a first value of the bit field to a first delay value for the transmission of the SRS, and a second value of the bit field to a second delay value for the transmission of the SRS.

In some examples, the base station may transmit to the user equipment a data set that maps a first value of the bit field to a first delay value for the transmission of the SRS, and a second value of the bit field to an indication to use a first available slot for the transmission of the SRS.

In some examples, the bit field is dedicated for indicating which of a plurality of delay values is to be used for the transmission of the SRS. In some examples, the bit field is a reallocated SRS trigger field or a time domain resource allocation (TDRA) field.

In some examples, the base station may transmit a radio resource control (RRC) message specifying that the bit field applies to all of a plurality of SRS resource sets defined for a bandwidth part.

In some examples, the base station may transmit a radio resource control (RRC) message specifying that the bit field applies to a subset of a plurality of SRS resource sets defined for a bandwidth part. In some examples, the base station may receive a data set that maps a first value for the bit field to a first delay value for a first SRS resource set of the plurality of SRS resource sets, the first value for the bit field to a second delay value for a second SRS resource set of the plurality of SRS resource sets, a second value for the bit field to a third delay value for the first SRS resource set of the plurality of SRS resource sets, and the second value for the bit field to a fourth delay value for the second SRS resource set of the plurality of SRS resource sets.

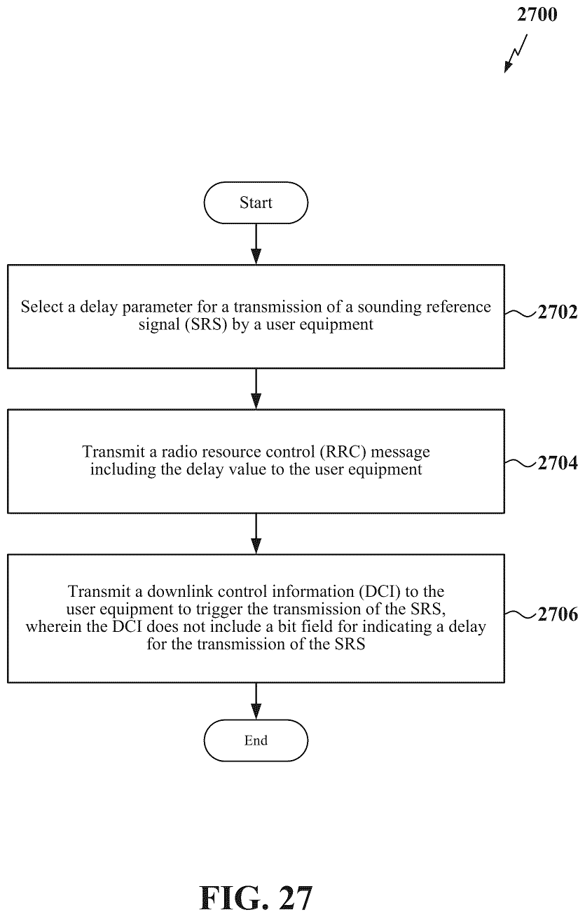

FIG. 27 is a flow chart illustrating an example wireless communication method 2700 according to some aspects of the disclosure. As described herein, some or all illustrated features may be omitted in a particular implementation within the scope of the present disclosure, and some illustrated features may not be required for implementation of all examples. In some examples, the wireless communication method 2700 may be carried out by the BS 2400 illustrated in FIG. 24. In some examples, the wireless communication method 2700 may be carried out by any suitable apparatus or means for carrying out the functions or algorithm described below.

At block 2702, a base station may select a delay parameter for a transmission of a sounding reference signal (SRS) by a user equipment. For example, the SRS configuration circuitry 2442, shown and described above in connection with FIG. 24, may provide a means to select a delay parameter for a transmission of a sounding reference signal (SRS) by a user equipment.

At block 2704, the base station may transmit a radio resource control (RRC) message including the delay value to the user equipment. For example, the SRS configuration circuitry 2442 together with the communication and processing circuitry 2441 and the transceiver 2410, shown and described above in connection with FIG. 24, may provide a means to transmit a radio resource control (RRC) message including the delay value to the user equipment.

At block 2706, the base station may transmit a downlink control information (DCI) to the user equipment to trigger the transmission of the SRS, wherein the DCI does not include a bit field for indicating the delay value for the transmission of the SRS. For example, the SRS configuration circuitry 2442 together with the communication and processing circuitry 2441 and the transceiver 2410, shown and described above in connection with FIG. 24, may provide a means to transmit a downlink control information (DCI) to the user equipment to trigger the transmission of the SRS.

In some examples, the delay parameter specifies a delay value for the transmission of the SRS. In some examples, the delay parameter specifies that the user equipment is to use a first available slot to transmit the SRS. In some examples, the delay parameter specifies an available a slot relative to a reference slot.

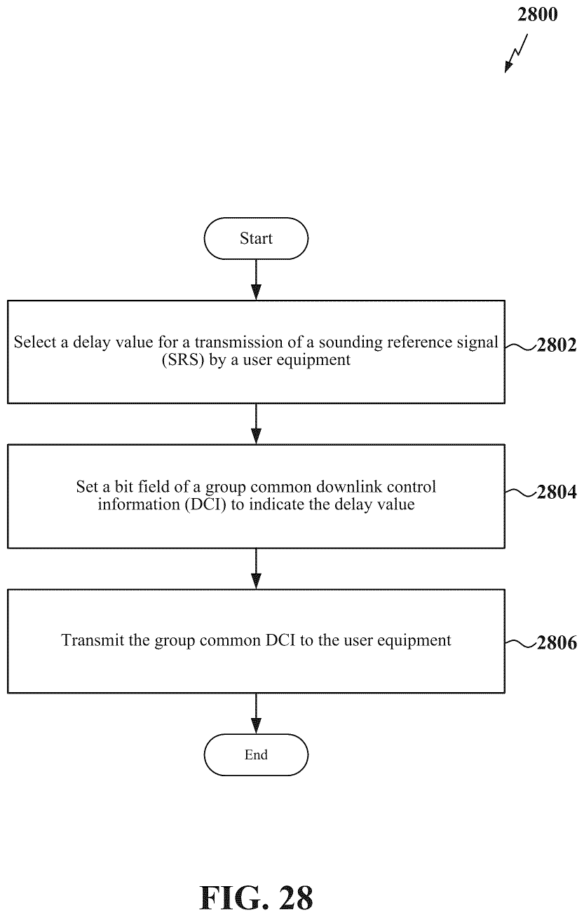

FIG. 28 is a flow chart illustrating an example wireless communication method 2800 according to some aspects of the disclosure. As described herein, some or all illustrated features may be omitted in a particular implementation within the scope of the present disclosure, and some illustrated features may not be required for implementation of all examples. In some examples, the wireless communication method 2800 may be carried out by the BS 2400 illustrated in FIG. 24. In some examples, the wireless communication method 2800 may be carried out by any suitable apparatus or means for carrying out the functions or algorithm described below.

At block 2802, a base station may select a delay value for a transmission of a sounding reference signal (SRS) by a user equipment. For example, the SRS configuration circuitry 2442, shown and described above in connection with FIG. 24, may provide a means to select a delay value for a transmission of a sounding reference signal (SRS) by a user equipment.

At block 2804, the base station may set a bit field of a group common downlink control information (DCI) to indicate the delay value. For example, the SRS configuration circuitry 2442, shown and described above in connection with FIG. 24, may provide a means to set a bit field of a group common downlink control information (DCI) to indicate the delay value.

At block 2806, the base station may transmit the group common DCI to the user equipment. For example, the SRS configuration circuitry 2442 together with the communication and processing circuitry 2441 and the transceiver 2410, shown and described above in connection with FIG. 24, may provide a means to transmit the group common DCI to the user equipment.

In some examples, the group common DCI is a format 2_3 DCI, and the group common DCI may include a component carrier block that includes the bit field. In some examples, the group common DCI is a format 2_3 DCI, and the group common DCI may include a payload that includes the bit field, and the bit field may include a plurality of bits that are mapped to a plurality of component carriers scheduled by the group common DCI. In some examples, the base station may transmit a radio resource control (RRC) message including a pointer that maps a first bit of the bit field to at least a first component carrier of the plurality of component carriers, and a second bit of the bit field to at least a second component carrier of the plurality of component carriers.

In some examples, the base station may transmit a radio resource control (RRC) message specifying that the bit field applies to all of a plurality of SRS resource sets defined for a bandwidth part. In some examples, the base station may transmit a radio resource control (RRC) message specifying that the bit field applies to a subset of a plurality of SRS resource sets defined for a bandwidth part.

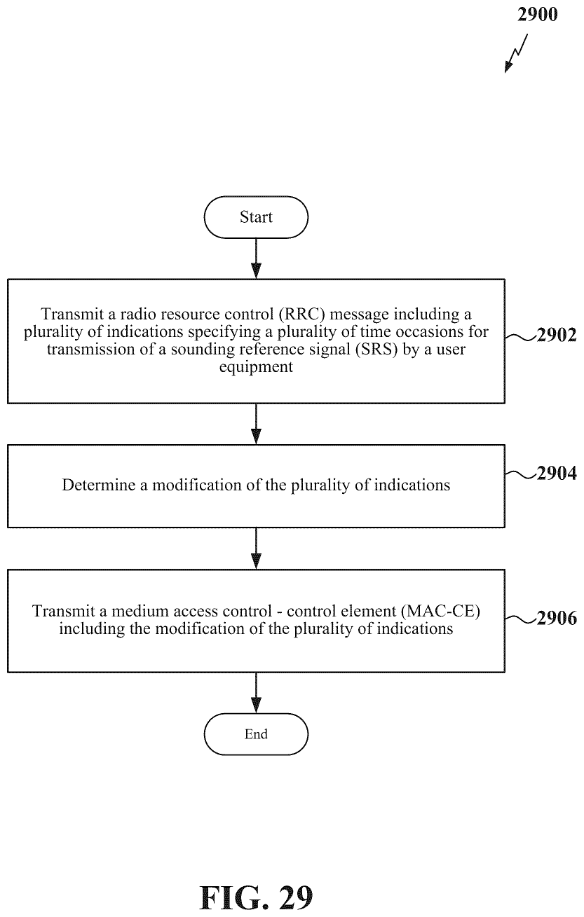

FIG. 29 is a flow chart illustrating an example wireless communication method 2900 according to some aspects of the disclosure. As described herein, some or all illustrated features may be omitted in a particular implementation within the scope of the present disclosure, and some illustrated features may not be required for implementation of all examples. In some examples, the wireless communication method 2900 may be carried out by the BS 2400 illustrated in FIG. 24. In some examples, the wireless communication method 2900 may be carried out by any suitable apparatus or means for carrying out the functions or algorithm described below.

At block 2902, a base station may transmit a radio resource control (RRC) message including a plurality of indications specifying a plurality of time occasions for transmission of a sounding reference signal (SRS) by a user equipment. For example, the SRS configuration circuitry 2442 together with the communication and processing circuitry 2441 and the transceiver 2410, shown and described above in connection with FIG. 24, may provide a means to transmit a radio resource control (RRC) message including a plurality of indications specifying a plurality of time occasions for transmission of a sounding reference signal (SRS) by a user equipment.

At block 2904, the base station may determine a modification of the plurality of indications. For example, the SRS configuration circuitry 2442, shown and described above in connection with FIG. 24, may provide a means to determine a modification of the plurality of indications.

At block 2906, the base station may transmit a medium access control-control element (MAC-CE) including the modification of the plurality of indications. For example, the SRS configuration circuitry 2442 together with the communication and processing circuitry 2441 and the transceiver 2410, shown and described above in connection with FIG. 24, may provide a means to transmit a medium access control-control element (MAC-CE) including the modification of the plurality of indications.

In some examples, the modification of the plurality of indications may include an update of at least one of the plurality of indications, an addition of at least one indication to the plurality of indications, or a deletion of at least one of the plurality of indications. In some examples, the modification of the plurality of indications may include modification of the plurality of indications for all SRS resource sets for each bandwidth part of each serving cell of the base station. In some examples, the modification of the plurality of indications may include modification of the plurality of indications for all SRS resource sets for a plurality of component carriers.

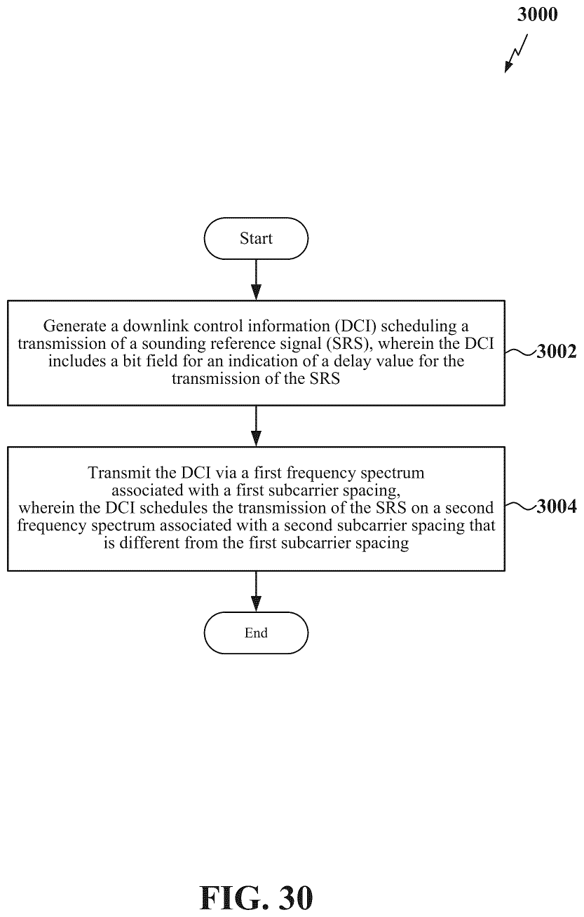

FIG. 30 is a flow chart illustrating an example wireless communication method 3000 according to some aspects of the disclosure. As described herein, some or all illustrated features may be omitted in a particular implementation within the scope of the present disclosure, and some illustrated features may not be required for implementation of all examples. In some examples, the wireless communication method 3000 may be carried out by the BS 2400 illustrated in FIG. 24. In some examples, the wireless communication method 3000 may be carried out by any suitable apparatus or means for carrying out the functions or algorithm described below.

At block 3002, a base station may generate a downlink control information (DCI) scheduling a transmission of a sounding reference signal (SRS), wherein the DCI includes a bit field for an indication of a delay value for the transmission of the SRS. For example, the SRS configuration circuitry 2442, shown and described above in connection with FIG. 24, may provide a means to generate a downlink control information (DCI) scheduling a transmission of a sounding reference signal (SRS).

At block 3004, the base station may transmit the DCI via a first frequency spectrum associated with a first subcarrier spacing, wherein the DCI schedules the transmission of the SRS on a second frequency spectrum associated with a second subcarrier spacing that is different from the first subcarrier spacing. For example, the SRS configuration circuitry 2442 together with the communication and processing circuitry 2441 and the transceiver 2410, shown and described above in connection with FIG. 24, may provide a means to transmit the DCI via a first frequency spectrum associated with a first subcarrier spacing.

In some examples, the base station may determine the delay value based on the first subcarrier spacing. In some examples, the base station may determine the delay value based on the second subcarrier spacing. In some examples, the indication specifies an available slot relative to a reference slot.

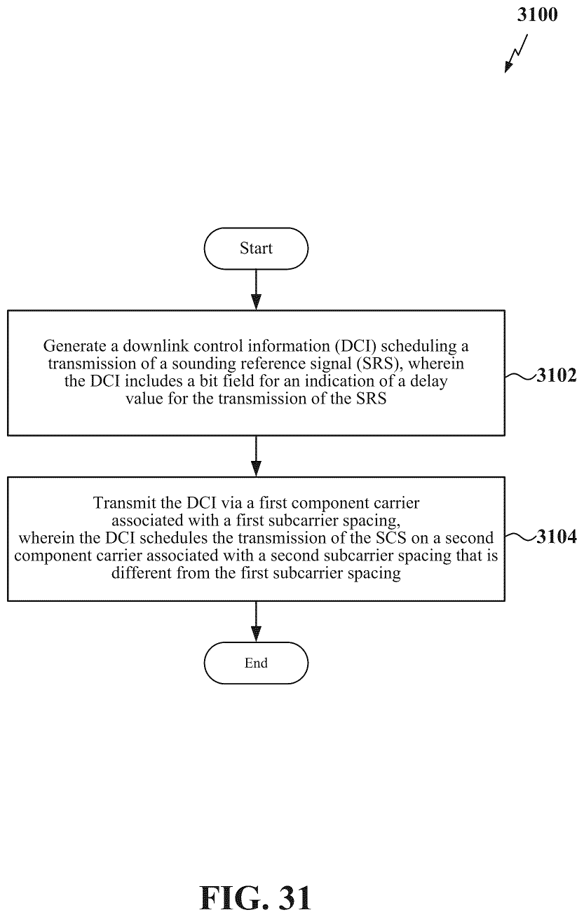

FIG. 31 is a flow chart illustrating an example wireless communication method 3000 according to some aspects of the disclosure. As described herein, some or all illustrated features may be omitted in a particular implementation within the scope of the present disclosure, and some illustrated features may not be required for implementation of all examples. In some examples, the wireless communication method 3100 may be carried out by the BS 2400 illustrated in FIG. 24. In some examples, the wireless communication method 3100 may be carried out by any suitable apparatus or means for carrying out the functions or algorithm described below.

At block 3102, a base station may generate a downlink control information (DCI) scheduling a transmission of a sounding reference signal (SRS), wherein the DCI may include a bit field for an indication of a delay value for the transmission of the SRS. For example, the SRS configuration circuitry 2442, shown and described above in connection with FIG. 24, may provide a means to generate a downlink control information (DCI) scheduling a transmission of a sounding reference signal (SRS).

At block 3104, the base station may transmit the DCI via a first component carrier associated with a first subcarrier spacing, wherein the DCI schedules the transmission of the SRS on a second component carrier associated with a second subcarrier spacing that is different from the first subcarrier spacing. For example, the SRS configuration circuitry 2442 together with the communication and processing circuitry 2441 and the transceiver 2410, shown and described above in connection with FIG. 24, may provide a means to transmit the DCI via a first component carrier associated with a first subcarrier spacing.

In some examples, a slot offset for the transmission of the SRS is based on a subcarrier spacing of the second component carrier.

In some examples, a method for wireless communication at a base station may include selecting a delay parameter for a transmission of a sounding reference signal (SRS) by a user equipment, setting a bit field of a downlink control information (DCI) to indicate the delay parameter, and transmitting the DCI to the user equipment.

In some examples, a base station may include a transceiver, a memory, and a processor communicatively coupled to the transceiver and the memory. The processor and the memory may be configured to select a delay parameter for a transmission of a sounding reference signal (SRS) by a user equipment, set a bit field of a downlink control information (DCI) to indicate the delay parameter, and transmit the DCI to the user equipment via the transceiver.

In some examples, a base station may include means for selecting a delay parameter for a transmission of a sounding reference signal (SRS) by a user equipment, means for setting a bit field of a downlink control information (DCI) to indicate the delay parameter, and means for transmitting the DCI to the user equipment.

In some examples, an article of manufacture for use by a base station includes a non-transitory computer-readable medium having stored therein instructions executable by one or more processors of the base station to select a delay parameter for a transmission of a sounding reference signal (SRS) by a user equipment, set a bit field of a downlink control information (DCI) to indicate the delay parameter, and transmit the DCI to the user equipment.

One or more of the following features may be applicable to one or more of the method, the apparatuses, and the computer-readable medium of the preceding paragraphs. The DCI may include a data scheduling DCI format 0_1, a DCI format 0_1, a DCI format 0_2, a DCI format 1_1, or a DCI format 1_2. The bit field may be a single bit. A transmitted data set may map a first value of the bit field to a first delay value for the transmission of the SRS and a second value of the bit field to a second delay value for the transmission of the SRS. A transmitted data set may map a first value of the bit field to a first delay value for the transmission of the SRS and a second value of the bit field to an indication to use a first available slot for the transmission of the SRS.

In one configuration, the base station 2400 includes means for determining a plurality of indications specifying a plurality of time occasions relative to a reference slot for transmission of a sounding reference signal (SRS) by a user equipment, means for transmitting the plurality of indications to the user equipment, and means for receiving the SRS at a time that is based on one of the plurality of indications. In one aspect, the aforementioned means may be the processor 2404 shown in FIG. 24 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 2404 is merely provided as an example, and other means for carrying out the described functions may be included within various aspects of the present disclosure, including but not limited to the instructions stored in the computer-readable medium 2406, or any other suitable apparatus or means described in any one or more of FIGS. 1, 2, 4, 5, and 24, and utilizing, for example, the methods and/or algorithms described herein in relation to FIGS. 25-31.

The methods shown in FIGS. 15-23 and 25-31 may include additional aspects, such as any single aspect or any combination of aspects described below and/or in connection with one or more other processes described elsewhere herein. The following provides an overview of several aspects of the present disclosure.

Aspect A1: A method for wireless communication at a user equipment, the method comprising: receiving a plurality of indications specifying a plurality of time occasions relative to a reference slot for transmission of a sounding reference signal (SRS) by the user equipment; and transmitting the SRS at a time that is based on a first indication of the plurality of indications.

Aspect A2: The method of aspect A1, wherein the plurality of indications comprises: a first delay value; and a second delay value.

Aspect A3: The method of aspect A2, wherein: the first delay value comprises a second indication to a first available slot; and the second delay value comprises a third indication to a second available slot that is different from the first available slot.

Aspect A4: The method of any of aspects A1 through A3, wherein the plurality of indications comprises: a first delay value; and an indication to use a first available slot.

Aspect A5: The method of aspect A4, wherein the indication to use the first available slot comprises a value of zero.

Aspect A6: The method of any of aspects A1 through A5, wherein: the plurality of indications are for a specified SRS resource set; and a time domain behavior of the specified SRS resource set is aperiodic.

Aspect A7: The method of any of aspects A1 through A6, wherein the plurality of indications comprises: at least one first delay value for a first SRS resource set of a plurality of SRS resource sets; and at least one second delay value for a second SRS resource set of the plurality of SRS resource sets.

Aspect A8: The method of any of aspects A1 through A7, wherein receiving the plurality of indications comprises receiving a radio resource control (RRC) configuration comprising a first field and a second field for the plurality of indications.

Aspect A9: The method of any of aspects A1 through A8, wherein the plurality of indications comprises: a first field that includes a first delay value; and a second field that includes a second delay value and a third delay value.

Aspect A10: The method of aspect A9, wherein: the first delay value comprises a second indication to a first available slot; the second delay value comprises a third indication to a second available slot that is different from the first available slot; and the third delay value comprises a fourth indication to a third available slot that is different from the second available slot.

Aspect A11: The method of any of aspects A1 through A10, wherein the plurality of indications comprises: a first field that includes a first delay value; and a second field that includes a second delay value and an indication to use a first available slot.

Aspect A12: The method of aspect A11, wherein the indication to use the first available slot comprises a value of zero.

Aspect A13: The method of any of aspects A1 through A12, further comprising: determining that the first indication is a smaller number than a second indication of the plurality of indications; and selecting the first indication based on the determining that the first indication is a smaller number than the second indication.

Aspect A14: The method of any of aspects A1 through A13, further comprising: determining that an uplink transmission should not be performed during a slot indicated by a second indication of the plurality of indications; and selecting the first indication based on the determining that the uplink transmission should not be performed during the slot indicated by the second indication.

Aspect A15: The method of any of aspects A1 through A14, further comprising: determining that the first indication comprises an indication to use a first available slot; and selecting the first indication based on the determining that the first indication comprises the indication to use the first available slot.

Aspect A16: The method of any of aspects A1 through A15, further comprising: receiving an indication selection parameter; and selecting the first indication based on the indication selection parameter.

Aspect A17: The method of any of aspects A1 through A16, further comprising: determining that a size of a resource allocation for the transmission of the SRS is less than a threshold; and selecting the first indication based on the determining that the size of the resource allocation for the transmission of the SRS is less than the threshold.

Aspect A18: The method of any of aspects A1 through A17, further comprising: determining whether frequency hopping is configured for the transmission of the SRS; and selecting the first indication based on the determining whether frequency hopping is configured for the transmission of the SRS.

Aspect A19: The method of any of aspects A1 through A18, further comprising: receiving a downlink control information (DCI) comprising a bit field; and selecting the first indication based on a value of the bit field.

Aspect A20: The method of aspect A19, wherein: the DCI comprises a data scheduling DCI format 0_1, a DCI format 0_1, a DCI format 0_2, a DCI format 1_1, or a DCI format 1_2; and the bit field is a single bit.

Aspect A21: The method of aspect A19, wherein the plurality of indications map: a first value of the bit field to a first delay value for the transmission of the SRS; and a second value of the bit field to a second delay value for the transmission of the SRS.

Aspect A22: The method of aspect A19, wherein the plurality of indications map: a first value of the bit field to a first delay value for the transmission of the SRS; and a second value of the bit field to an indication to use a first available slot for the transmission of the SRS.

Aspect A23: The method of aspect A19, wherein the bit field is dedicated for indicating which of a plurality of delay values is to be used for the transmission of the SRS.

Aspect A24: The method of aspect A19, wherein the bit field is reallocated for indicating which of a plurality of delay values is to be used for the transmission of the SRS.

Aspect A25: The method of aspect A24, wherein an SRS request field is used to indicate the bit field.

Aspect A26: The method of aspect A19, further comprising: receiving a radio resource control (RRC) message specifying that the value of the bit field applies to all of a plurality of SRS resource sets defined for a bandwidth part.

Aspect A27: The method of aspect A19, further comprising: receiving a message specifying that the value of the bit field applies to a subset of a plurality of SRS resource sets defined for a bandwidth part.

Aspect A28: The method of aspect A27, wherein the plurality of indications map: a first value for the bit field to a first delay value for a first SRS resource set of the plurality of SRS resource sets; the first value for the bit field to a second delay value for a second SRS resource set of the plurality of SRS resource sets; a second value for the bit field to a third delay value for the first SRS resource set of the plurality of SRS resource sets; and the second value for the bit field to a fourth delay value for the second SRS resource set of the plurality of SRS resource sets.

Aspect A29: The method of aspect A19, wherein: the DCI triggers the transmission of the SRS and does not schedule a data transmission; and the bit field is a plurality of bits where each bit of the plurality of bits is mapped to a respective triggered SRS resource set.

Aspect A30: The method of any of aspect A1, further comprising: receiving downlink control information (DCI); and responsive to determining that a bit field of the DCI for the plurality of indications is disabled, selecting a delay value of zero for transmitting the SRS, selecting a default delay value for transmitting the SRS, selecting a radio resource control (RRC) configured delay value for transmitting the SRS, or selecting a first available slot for transmitting the SRS.

Aspect A31: The method of any of aspects A1 through A30, further comprising: receiving a group common downlink control information (DCI), wherein the group common DCI includes a bit field for indicating at least one delay parameter for the transmission of the SRS; and selecting the first indication based on a value of the bit field.

Aspect A32: The method of aspect A31, wherein: the group common DCI is a format 2_3 DCI; and the group common DCI comprises a component carrier block that includes the bit field.

Aspect A33: The method of aspect A31, wherein: the group common DCI is a format 2_3 DCI; and the group common DCI comprises a payload that includes the bit field; and the bit field comprises a plurality of bits that are mapped to a plurality of component carriers scheduled by the group common DCI.

Aspect A34: The method of aspect A33, further comprising receiving a radio resource control (RRC) message comprising a pointer that maps: a first bit of the bit field to at least a first component carrier of the plurality of component carriers; and a second bit of the bit field to at least a second component carrier of the plurality of component carriers.

Aspect A35: The method of aspect A31, further comprising: receiving a radio resource control (RRC) message specifying that the bit field applies to all of a plurality of SRS resource sets defined for a bandwidth part.

Aspect A36: The method of aspect A31, further comprising: receiving a radio resource control (RRC) message specifying that the bit field applies to a subset of a plurality of SRS resource sets defined for a bandwidth part.

Aspect A37: The method of any of aspects A1 through A36, further comprising: receiving a medium access control-control element (MAC-CE) comprising a modification of the plurality of indications.

Aspect A38: The method of aspect A37, wherein the modification of the plurality of indications comprises an update of at least one of the plurality of indications, an addition of at least one indication to the plurality of indications, or a deletion of at least one of the plurality of indications.

Aspect A39: The method of aspect A37, wherein the modification of the plurality of indications comprises: modification of the plurality of indications for all SRS resource sets for each bandwidth part of each serving cell of the base station.

Aspect A40: The method of aspect A37, wherein the modification of the plurality of indications comprises: modification of the plurality of indications for all SRS resource sets for a plurality of component carriers.

Aspect A41: The method of any of aspects A1 through A40, further comprising: determining an available slot for the transmission of the SRS based on the first indication; wherein transmitting the SRS at a time that is based on the first indication comprises transmitting the SRS during the available slot.

Aspect A42: The method of aspect A41, wherein determining the available slot comprises at least one of: verifying that a candidate slot indicated by the first indication is defined as an uplink slot, a special slot, or a flexible slot with sufficient time-domain and frequency-domain allocation for the transmission of the SRS, verifying that the transmission of the SRS does not collide with a higher priority uplink signal or uplink channel scheduled during the candidate slot, verifying that there is no change of an active bandwidth after a triggering DCI is received, verifying that a slot format indicator was not received after the plurality of indications was received, or a combination thereof.

Aspect A43: The method of aspect A42, wherein the transmission of the SRS is scheduled as a time division duplex transmission on unpaired spectrum.

Aspect A44: The method of aspect A41, wherein determining the available slot comprises at least one of: verifying that a candidate slot indicated by the first indication is defined as an uplink slot or a flexible slot with sufficient time-domain and frequency-domain allocation for the transmission of the SRS, verifying that the transmission of the SRS does not collide with a higher priority uplink signal or uplink channel scheduled during the candidate slot, or a combination thereof.

Aspect A45: The method of aspect A44, wherein the transmission of the SRS is scheduled as a frequency division duplex transmission on paired spectrum.

Aspect A46: The method of any of aspects A1 through A45, further comprising: receiving a downlink control information (DCI) via a first frequency spectrum associated with a first subcarrier spacing, wherein the DCI schedules the transmission of the SRS on a second frequency spectrum associated with a second subcarrier spacing that is different from the first subcarrier spacing; mapping a first slot number of the DCI associated with the first subcarrier spacing to a second slot number associated with the second subcarrier spacing; identifying a reference slot based on the second slot number and a slot offset; and identifying an uplink slot for the transmission of the SRS based on the reference slot and the first indication.

Aspect A47: The method of aspect A46, wherein: the first indication is associated with the first subcarrier spacing; the method further comprises mapping the first indication to a second indication associated with the second subcarrier spacing; and identifying the uplink slot for the transmission of the SRS based on the second slot number and the first indication comprises identifying the uplink slot for the transmission of the SRS based on the second slot number and the second indication.

Aspect A48: The method of aspect A46, wherein the first frequency spectrum and the second frequency spectrum are allocated as paired spectrum for frequency division duplex communication.

Aspect A49: The method of any of aspects A1 through A48, further comprising: receiving a downlink control information (DCI) via a first component carrier associated with a first subcarrier spacing, wherein the DCI schedules the transmission of the SRS on a second component carrier associated with a second subcarrier spacing that is different from the first subcarrier spacing; identifying the reference slot based on a slot of the DCI and a slot offset associated with the second subcarrier spacing; and identifying an uplink slot for the transmission of the SRS based on the reference slot and the first indication.

Aspect A50: The method of aspect A49, wherein the slot offset is based on a time offset between the first component carrier and the second component carrier.

Aspect A51: The method of any of aspects A1 through A50, further comprising: receiving a downlink control information (DCI) comprising a bit field; and selecting the first indication based on a value of the bit field; wherein the value of the bit field comprises an absolute delay value.

Aspect A52: The method of aspect A51, wherein the absolute delay value indicates a specific number of slots to delay the transmission of the SRS.

Aspect A53: The method of any of aspects A1 through A52, wherein the reference slot is a slot in which a downlink control information (DCI) is received.

Aspect A54: The method of any of aspects A1 through A52, wherein the reference slot follows a downlink control information (DCI) by a quantity of slots that is specified by a radio resource control (RRC) configuration.

Aspect A55: A user equipment (UE) comprising: a transceiver configured to communicate with a radio access network, a memory, and a processor communicatively coupled to the transceiver and the memory, wherein the processor and the memory are configured to perform any one of aspects A1 through A54.

Aspect A56: An apparatus configured for wireless communication comprising at least one means for performing any one of aspects A1 through A54.

Aspect A57: A non-transitory computer-readable medium storing computer-executable code, comprising code for causing an apparatus to perform any one of aspects A1 through A54.

Aspect A61: A method for wireless communication at a base station, the method comprising: transmitting to a user equipment a plurality of indications specifying a plurality of time occasions relative to a reference slot for transmission of a sounding reference signal (SRS) by the user equipment; and receiving the SRS at a time that is based on one of the plurality of indications.

Aspect A62: The method of aspect A61, wherein the plurality of indications comprises: a first delay value; and a second delay value.

Aspect A63: The method of aspect A62, wherein: the first delay value comprises a second indication to a first available slot; and the second delay value comprises a third indication to a second available slot that is different from the first available slot.

Aspect A64: The method of any of aspects A61 through A63, wherein the plurality of indications comprises: a first delay value; and an indication to use a first available slot.

Aspect A65: The method of aspect A64, wherein the indication to use the first available slot comprises a value of zero.

Aspect A66: The method of any of aspects A61 through A65, further comprising: selecting the plurality of indications based on a sub-carrier spacing to be used by the user equipment for the transmission of the SRS.

Aspect A67: The method of any of aspects A61 through A66, further comprising: selecting the plurality of indications based on a sub-carrier spacing of a bandwidth part to be used by the user equipment for the transmission of the SRS.

Aspect A68: The method of any of aspects A61 through A67, wherein the plurality of indications are for a specified SRS resource set.

Aspect A69: The method of aspect A68, wherein a time domain behavior of the specified SRS resource set is aperiodic.

Aspect A70: The method of any of aspects A61 through A69, wherein transmitting the plurality of indications comprises transmitting a radio resource control (RRC) configuration comprising a first field and a second field for the plurality of indications.

Aspect A71: The method of any of aspects A61 through A70, wherein the plurality of indications comprises: a first field that includes a first delay value; and a second field that includes a second delay value and a third delay value.

Aspect A72: The method of any of aspects A61 through A71, wherein: the first delay value comprises a first indication to a first available slot; the second delay value comprises a second indication to a second available slot that is different from the first available slot; and the third delay value comprises a third indication to a third available slot that is different from the second available slot.

Aspect A73: The method of any of aspects A61 through A72, wherein the plurality of indications comprises: a first field that includes a first delay value; and a second field that includes a second delay value and an indication to use a first available slot.

Aspect A74: The method of aspect A73, wherein the indication to use the first available slot comprises a value of zero.

Aspect A75: The method of any of aspects A61 through A74, further comprising: selecting a delay parameter for the transmission of the SRS by the user equipment; setting a bit field of a downlink control information (DCI) to indicate the delay parameter; and transmitting the DCI to the user equipment.

Aspect A76: The method of aspect A75, further comprising: transmitting a radio resource control (RRC) message specifying that the bit field applies to all of a plurality of SRS resource sets defined for a bandwidth part.

Aspect A77: The method of aspect A75, further comprising: transmitting a radio resource control (RRC) message specifying that the bit field applies to a subset of a plurality of SRS resource sets defined for a bandwidth part.

Aspect A78: The method of aspect A77, wherein the plurality of indications map: a first value for the bit field to a first delay value for a first SRS resource set of the plurality of SRS resource sets; the first value for the bit field to a second delay value for a second SRS resource set of the plurality of SRS resource sets; a second value for the bit field to a third delay value for the first SRS resource set of the plurality of SRS resource sets; and the second value for the bit field to a fourth delay value for the second SRS resource set of the plurality of SRS resource sets.

Aspect A79: The method of any of aspects A61 through A78, further comprising: determining that the user equipment is not to delay the transmission of the SRS; and transmitting a downlink control information (DCI) to the user equipment to trigger the transmission of the SRS, wherein the DCI does not include a bit field for indicating a delay value for the transmission of the SRS.

Aspect A80: The method of any of aspects A61 through A79, further comprising: selecting a delay value for the transmission of the SRS by the user equipment; transmitting a radio resource control (RRC) message specifying the delay value to the user equipment; and transmitting a downlink control information (DCI) to the user equipment to trigger the transmission of the SRS, wherein the DCI does not include a bit field for indicating the delay value.

Aspect A81: The method of any of aspects A61 through A80, further comprising: transmitting a radio resource control (RRC) message comprising an indication that the user equipment is to use a first available slot to transmit the SRS; and transmitting a downlink control information (DCI) to the user equipment to trigger the transmission of the SRS, wherein the DCI does not include a bit field for indicating a delay value for the transmission of the SRS.

Aspect A82: The method of any of aspects A61 through A81, further comprising: selecting a delay value for the transmission of the SRS by the user equipment; setting a bit field of a group common downlink control information (DCI) to indicate the delay value; and transmitting the DCI to the user equipment.

Aspect A83: The method of aspect A82, wherein: the group common DCI is a format 2_3 DCI; and the group common DCI comprises a component carrier block that includes the bit field.

Aspect A84: The method of aspect A82, wherein: the group common DCI is a format 2_3 DCI; and the group common DCI comprises a payload that includes the bit field; and the bit field comprises a plurality of bits that are mapped to a plurality of component carriers scheduled by the group common DCI.

Aspect A85: The method of aspect A84, further comprising transmitting a radio resource control (RRC) message comprising a pointer that maps: a first bit of the bit field to at least a first component carrier of the plurality of component carriers; and a second bit of the bit field to at least a second component carrier of the plurality of component carriers.

Aspect A86: The method of aspect A82, further comprising: transmitting a radio resource control (RRC) message specifying that the bit field applies to all of a plurality of SRS resource sets defined for a bandwidth part.

Aspect A87: The method of aspect A82, further comprising: transmitting a radio resource control (RRC) message specifying that the bit field applies to a subset of a plurality of SRS resource sets defined for a bandwidth part.

Aspect A88: The method of any of aspects A61 through A87, further comprising: determining a modification of the plurality of indications; transmitting a medium access control-control element (MAC-CE) comprising the modification of the plurality of indications.

Aspect A89: The method of aspect A88, wherein the modification of the plurality of indications comprises an update of at least one of the plurality of indications, an addition of at least one indication to the plurality of indications, or a deletion of at least one of the plurality of indications.

Aspect A90: The method of aspect A88, wherein the modification of the plurality of indications comprises: modification of the plurality of indications for all SRS resource sets for each bandwidth part of each serving cell of the base station.

Aspect A91: The method of aspect A88, wherein the modification of the plurality of indications comprises: modification of the plurality of indications for all SRS resource sets for a plurality of component carriers.

Aspect A92: The method of any of aspects A61 through A91, further comprising: transmitting a downlink control information (DCI) via a first frequency spectrum associated with a first subcarrier spacing, wherein the DCI schedules the transmission of the SRS on a second frequency spectrum associated with a second subcarrier spacing that is different from the first subcarrier spacing; wherein the DCI comprises a bit field for an indication of a delay value for the transmission of the SRS.

Aspect A93: The method of any of aspects A61 through A92, further comprising: transmitting a downlink control information (DCI) via a first component carrier associated with a first subcarrier spacing, wherein the DCI schedules the transmission of the SRS on a second component carrier associated with a second subcarrier spacing that is different from the first subcarrier spacing; wherein the DCI comprises a bit field for an indication of a delay value for the transmission of the SRS.

Aspect A94: The method of any of aspects A61 through A92, further comprising: determining an absolute delay value for delaying the transmission of the SRS; and transmitting a downlink control information (DCI) comprising the absolute delay value.

Aspect A95: The method of aspect A94, wherein the absolute delay value indicates a specific number of slots to delay the transmission of the SRS.

Aspect A96: A base station (BS) comprising: a transceiver, a memory, and a processor communicatively coupled to the transceiver and the memory, wherein the processor and the memory are configured to perform any one of aspects A61 through A95.

Aspect A97: An apparatus configured for wireless communication comprising at least one means for performing any one of aspects A61 through A95.

Aspect A98: A non-transitory computer-readable medium storing computer-executable code, comprising code for causing an apparatus to perform any one of aspects A61 through A95.

Aspect A101: A method for wireless communication at a user equipment, the method comprising: receiving a downlink control information (DCI) comprising a bit field; identifying a delay parameter based on a value of the bit field; and transmitting a sounding reference signal (SRS) at a time that is based on the delay parameter.

Aspect A102: The method of aspect A101, wherein: the DCI comprises a data scheduling DCI format 0_1, a DCI format 0_1, a DCI format 0_2, a DCI format 1_1, or a DCI format 1_2; and the bit field is a single bit.

Aspect A103: The method of aspect A101 or A102, further comprising receiving a data set that maps: a first value of the bit field to a first delay value for the transmitting of the SRS; and a second value of the bit field to a second delay value for the transmitting of the SRS.

Aspect A104: The method of any of aspects A101 through A103, further comprising receiving a data set that maps: a first value of the bit field to a first delay value for the transmitting of the SRS; and a second value of the bit field to an indication to use a first available slot for the transmitting of the SRS.

Aspect A105: The method of any of aspects A101 through A104, wherein the bit field is dedicated for indicating which of a plurality of delay values is to be used for the transmitting of the SRS.

Aspect A106: The method of any of aspects A101 through A105, wherein the bit field is reallocated for indicating which of a plurality of delay values is to be used for the transmitting of the SRS.

Aspect A107: The method of aspect A106, wherein the bit field is a reallocated SRS trigger field or a time domain resource allocation (TDRA) field.

Aspect A108: The method of any of aspects A101 through A107, further comprising: receiving a message specifying that the value of the bit field applies to all of a plurality of SRS resource sets defined for a bandwidth part.

Aspect A109: The method of aspect A108, wherein the message comprises a radio resource control (RRC) configuration.

Aspect A110: The method of any of aspects A101 through A109, further comprising: receiving a message specifying that the value of the bit field applies to a subset of a plurality of SRS resource sets defined for a bandwidth part.

Aspect A111: The method of aspect A110, further comprising receiving a data set that maps: a first value for the bit field to a first delay value for a first SRS resource set of the plurality of SRS resource sets; the first value for the bit field to a second delay value for a second SRS resource set of the plurality of SRS resource sets; a second value for the bit field to a third delay value for the first SRS resource set of the plurality of SRS resource sets; and the second value for the bit field to a fourth delay value for the second SRS resource set of the plurality of SRS resource sets.

Aspect A112: The method of any of aspects A101 through A111, wherein: the DCI triggers the transmission of the SRS and does not schedule a data transmission; and the bit field is a plurality of bits.

Aspect A113: A user equipment (UE) comprising: a transceiver configured to communicate with a radio access network, a memory, and a processor communicatively coupled to the transceiver and the memory, wherein the processor and the memory are configured to perform any one of aspects A101 through A112.

Aspect A114: An apparatus configured for wireless communication comprising at least one means for performing any one of aspects A101 through A112.

Aspect A115: A non-transitory computer-readable medium storing computer-executable code, comprising code for causing an apparatus to perform any one of aspects A101 through A112.

Aspect A121: A method for wireless communication at a base station, the method comprising: selecting a delay parameter for a transmission of a sounding reference signal (SRS) by a user equipment; setting a bit field of a downlink control information (DCI) to indicate the delay parameter; and transmitting the DCI to the user equipment.

Aspect A122: The method of aspect A121, wherein: the DCI comprises a data scheduling DCI format 0_1, a DCI format 0_1, a DCI format 0_2, a DCI format 1_1, or a DCI format 1_2; and the bit field is a single bit.

Aspect A123: The method of aspect A121 or A122, further comprising transmitting to the user equipment a data set that maps: a first value of the bit field to a first delay value for the transmission of the SRS; and a second value of the bit field to a second delay value for the transmission of the SRS.

Aspect A124: The method of any of aspects A121 through A123, further comprising transmitting to the user equipment a data set that maps: a first value of the bit field to a first delay value for the transmission of the SRS; and a second value of the bit field to an indication to use a first available slot for the transmission of the SRS.

Aspect A125: The method of any of aspects A121 through A124, wherein the bit field is dedicated for indicating which of a plurality of delay values is to be used for the transmission of the SRS.

Aspect A126: The method of any of aspects A121 through A125, wherein the bit field is a reallocated SRS trigger field or a time domain resource allocation (TDRA) field.

Aspect A127: The method of any of aspects A121 through A126, further comprising: transmitting a radio resource control (RRC) message specifying that the bit field applies to all of a plurality of SRS resource sets defined for a bandwidth part.

Aspect A128: The method of any of aspects A121 through A127, further comprising: transmitting a radio resource control (RRC) message specifying that the bit field applies to a subset of a plurality of SRS resource sets defined for a bandwidth part.

Aspect A129: The method of aspect A128, further comprising transmitting to the user equipment a data set that maps: a first value for the bit field to a first delay value for a first SRS resource set of the plurality of SRS resource sets; the first value for the bit field to a second delay value for a second SRS resource set of the plurality of SRS resource sets; a second value for the bit field to a third delay value for the first SRS resource set of the plurality of SRS resource sets; and the second value for the bit field to a fourth delay value for the second SRS resource set of the plurality of SRS resource sets.

Aspect A130: A base station (BS) comprising: a transceiver, a memory, and a processor communicatively coupled to the transceiver and the memory, wherein the processor and the memory are configured to perform any one of aspects A121 through A129.

Aspect A131: An apparatus configured for wireless communication comprising at least one means for performing any one of aspects A121 through A129.

Aspect A132: A non-transitory computer-readable medium storing computer-executable code, comprising code for causing an apparatus to perform any one of aspects A121 through A129.

Aspect A141: A method for wireless communication at a user equipment, the method comprising: receiving a radio resource control (RRC) message comprising a delay parameter for a transmission of a sounding reference signal (SRS); and receiving a downlink control information (DCI) that triggers the transmission of the SRS, wherein the DCI does not include a bit field for indicating a delay for the transmission of the SRS; and transmitting the SRS according to the delay parameter.

Aspect A142: The method of aspect A141, wherein: the delay parameter specifies a delay value for the transmission of the SRS; and the transmitting the SRS according to the delay parameter comprises transmitting the SRS according to the delay value.

Aspect A143: The method of aspect A141 or A142, wherein: the delay parameter specifies that the user equipment is to use a first available slot to transmit the SRS; and the transmitting the SRS according to the delay parameter comprises transmitting the SRS during the first available slot.

Aspect A144: The method of any of aspects A141 through A143, wherein the delay parameter specifies an available slot relative to a reference slot.

Aspect A145: A user equipment (UE) comprising: a transceiver configured to communicate with a radio access network, a memory, and a processor communicatively coupled to the transceiver and the memory, wherein the processor and the memory are configured to perform any one of aspects A141 through A144.

Aspect A146: An apparatus configured for wireless communication comprising at least one means for performing any one of aspects A141 through A144.

Aspect A147: A non-transitory computer-readable medium storing computer-executable code, comprising code for causing an apparatus to perform any one of aspects A141 through A144.

Aspect A151: A method for wireless communication at a base station, the method comprising: selecting a delay parameter for a transmission of a sounding reference signal (SRS) by a user equipment; transmitting a radio resource control (RRC) message comprising the delay parameter to the user equipment; and transmitting a downlink control information (DCI) to the user equipment to trigger the transmission of the SRS, wherein the DCI does not include a bit field for indicating a delay for the transmission of the SRS.

Aspect A152: The method of aspect A151, wherein the delay parameter specifies a delay value for the transmission of the SRS.

Aspect A153: The method of aspect A151 or A152, wherein the delay parameter specifies that the user equipment is to use a first available slot to transmit the SRS.

Aspect A154: The method of any of aspects A151 through A153, wherein the delay parameter specifies an available a slot relative to a reference slot.

Aspect A155: A base station (BS) comprising: a transceiver, a memory, and a processor communicatively coupled to the transceiver and the memory, wherein the processor and the memory are configured to perform any one of aspects A151 through A154.

Aspect A156: An apparatus configured for wireless communication comprising at least one means for performing any one of aspects A151 through A154.

Aspect A157: A non-transitory computer-readable medium storing computer-executable code, comprising code for causing an apparatus to perform any one of aspects A151 through A154.

Aspect A161: A method for wireless communication at a user equipment, the method comprising: receiving a group common downlink control information (DCI), wherein the group common DCI includes a bit field for indicating at least one delay for a transmission of a sounding reference signal (SRS); identifying a delay parameter based on a value of the bit field; and transmitting the SRS at a time that is based on the delay parameter.

Aspect A162: The method of aspect A161, wherein: the group common DCI is a format 2_3 DCI; and the group common DCI comprises a component carrier block that includes the bit field.

Aspect A163: The method of aspect A161 or A162, wherein: the group common DCI is a format 2_3 DCI; and the group common DCI comprises a payload that includes the bit field; and the bit field comprises a plurality of bits that are mapped to a plurality of component carriers scheduled by the group common DCI.

Aspect A164: The method of aspect A163, further comprising receiving a radio resource control (RRC) message comprising a pointer that maps: a first bit of the bit field to at least a first component carrier of the plurality of component carriers; and a second bit of the bit field to at least a second component carrier of the plurality of component carriers.

Aspect A165: The method of any of aspects A161 through A164, further comprising: receiving a radio resource control (RRC) message specifying that the bit field applies to all of a plurality of SRS resource sets defined for a bandwidth part.

Aspect A166: The method of any of aspects A161 through A165, further comprising: receiving a radio resource control (RRC) message specifying that the bit field applies to a subset of a plurality of SRS resource sets defined for a bandwidth part.

Aspect A167: A user equipment (UE) comprising: a transceiver configured to communicate with a radio access network, a memory, and a processor communicatively coupled to the transceiver and the memory, wherein the processor and the memory are configured to perform any one of aspects A161 through A166.

Aspect A168: An apparatus configured for wireless communication comprising at least one means for performing any one of aspects A161 through A166.

Aspect A169: A non-transitory computer-readable medium storing computer-executable code, comprising code for causing an apparatus to perform any one of aspects A161 through A166.

Aspect A171: A method for wireless communication at a base station, the method comprising: selecting a delay value for a transmission of a sounding reference signal (SRS) by a user equipment; setting a bit field of a group common downlink control information (DCI) to indicate the delay value; and transmitting the group common DCI to the user equipment.

Aspect A172: The method of aspect A171, wherein: the group common DCI is a format 2_3 DCI; and the group common DCI comprises a component carrier block that includes the bit field.

Aspect A173: The method of aspect A171 or A172, wherein: the group common DCI is a format 2_3 DCI; and the group common DCI comprises a payload that includes the bit field; and the bit field comprises a plurality of bits that are mapped to a plurality of component carriers scheduled by the group common DCI.

Aspect A174: The method of aspect A173, further comprising transmitting a radio resource control (RRC) message comprising a pointer that maps: a first bit of the bit field to at least a first component carrier of the plurality of component carriers; and a second bit of the bit field to at least a second component carrier of the plurality of component carriers.

Aspect A175: The method of any of aspects A171 through A174, further comprising: transmitting a radio resource control (RRC) message specifying that the bit field applies to all of a plurality of SRS resource sets defined for a bandwidth part.

Aspect A176: The method of any of aspects A171 through A175, further comprising: transmitting a radio resource control (RRC) message specifying that the bit field applies to a subset of a plurality of SRS resource sets defined for a bandwidth part.

Aspect A177: A base station (BS) comprising: a transceiver, a memory, and a processor communicatively coupled to the transceiver and the memory, wherein the processor and the memory are configured to perform any one of aspects A171 through A176.

Aspect A178: An apparatus configured for wireless communication comprising at least one means for performing any one of aspects A171 through A176.

Aspect A179: A non-transitory computer-readable medium storing computer-executable code, comprising code for causing an apparatus to perform any one of aspects A171 through A176.

Aspect A181: A method for wireless communication at a user equipment, the method comprising: receiving a radio resource control (RRC) message comprising a plurality of indications specifying a plurality of time occasions for transmission of a sounding reference signal (SRS) by the user equipment; and receiving a medium access control-control element (MAC-CE) comprising a modification of the plurality of indications.

Aspect A182: The method of aspect A181, wherein the modification of the plurality of indications comprises an update of at least one of the plurality of indications, an addition of at least one indication to the plurality of indications, or a deletion of at least one of the plurality of indications.

Aspect A183: The method of aspect A181 or A182, wherein the modification of the plurality of indications comprises: modification of the plurality of indications for all SRS resource sets for each bandwidth part of each serving cell of a base station.

Aspect A184: The method of any of aspects A181 through A183, wherein the modification of the plurality of indications comprises: modification of the plurality of indications for all SRS resource sets for a plurality of component carriers.

Aspect A185: A user equipment (UE) comprising: a transceiver configured to communicate with a radio access network, a memory, and a processor communicatively coupled to the transceiver and the memory, wherein the processor and the memory are configured to perform any one of aspects A181 through A184.

Aspect A186: An apparatus configured for wireless communication comprising at least one means for performing any one of aspects A181 through A184.

Aspect A187: A non-transitory computer-readable medium storing computer-executable code, comprising code for causing an apparatus to perform any one of aspects A181 through A184.

Aspect A191: A method for wireless communication at a base station, the method comprising: transmitting a radio resource control (RRC) message comprising a plurality of indications specifying a plurality of time occasions for transmission of a sounding reference signal (SRS) by a user equipment; determining a modification of the plurality of indications; and transmitting a medium access control-control element (MAC-CE) comprising the modification of the plurality of indications.

Aspect A192: The method of aspect A191, wherein the modification of the plurality of indications comprises an update of at least one of the plurality of indications, an addition of at least one indication to the plurality of indications, or a deletion of at least one of the plurality of indications.

Aspect A193: The method of aspect A191 or A192, wherein the modification of the plurality of indications comprises: modification of the plurality of indications for all SRS resource sets for each bandwidth part of each serving cell of the base station.

Aspect A194: The method of any of aspects A191 through A193, wherein the modification of the plurality of indications comprises: modification of the plurality of indications for all SRS resource sets for a plurality of component carriers.

Aspect A195: A base station (BS) comprising: a transceiver, a memory, and a processor communicatively coupled to the transceiver and the memory, wherein the processor and the memory are configured to perform any one of aspects A191 through A194.

Aspect A196: An apparatus configured for wireless communication comprising at least one means for performing any one of aspects A191 through A194.

Aspect A197: A non-transitory computer-readable medium storing computer-executable code, comprising code for causing an apparatus to perform any one of aspects A191 through A194.

Aspect A201: A method for wireless communication at a user equipment, the method comprising: receiving a downlink control information (DCI) comprising a bit field; identifying a delay parameter based on a value of the bit field; determining an available slot for transmission of a sounding reference signal (SRS) based on the delay parameter; and transmitting the SRS during the available slot.

Aspect A202: The method of aspect A201, wherein determining the available slot comprises at least one of: verifying that a candidate slot indicated by the delay parameter is defined as an uplink slot, a special slot, or a flexible slot with sufficient time-domain and frequency-domain allocation for the transmission of the SRS, verifying that the transmission of the SRS does not collide with a higher priority uplink signal or uplink channel scheduled during the candidate slot, verifying that there is no change of an active bandwidth after a triggering DCI is received, verifying that a slot format indicator was not received after an SRS allocation for the transmission of the SRS was received, or a combination thereof.

Aspect A203: The method of aspect A202, wherein the transmission of the SRS is scheduled as a time division duplex transmission on unpaired spectrum.

Aspect A204: The method of any of aspects A201 through A203, wherein determining the available slot comprises at least one of: verifying that a candidate slot indicated by the bit field is defined as an uplink slot or a flexible slot with sufficient time-domain and frequency-domain allocation for the transmission of the SRS, verifying that the transmission of the SRS does not collide with a higher priority uplink signal or uplink channel scheduled during the candidate slot, or a combination thereof.

Aspect A205: The method of aspect A204, wherein the transmission of the SRS is scheduled as a frequency division duplex transmission on paired spectrum.

Aspect A206: A user equipment (UE) comprising: a transceiver configured to communicate with a radio access network, a memory, and a processor communicatively coupled to the transceiver and the memory, wherein the processor and the memory are configured to perform any one of aspects A201 through A205.

Aspect A207: An apparatus configured for wireless communication comprising at least one means for performing any one of aspects A201 through A205.

Aspect A208: A non-transitory computer-readable medium storing computer-executable code, comprising code for causing an apparatus to perform any one of aspects A201 through A205.

Aspect A211: A method for wireless communication at a user equipment, the method comprising: receiving a downlink control information (DCI) via a first frequency spectrum associated with a first subcarrier spacing, wherein the DCI schedules a transmission of a sounding reference signal (SRS) on a second frequency spectrum associated with a second subcarrier spacing that is different from the first subcarrier spacing; mapping a first slot number of the DCI associated with the first subcarrier spacing to a second slot number associated with the first subcarrier spacing; and identifying an uplink slot for the transmission of the SRS based on the second slot number and a first indication of a delay value for the transmission of the SRS.

Aspect A212: The method of aspect A211, wherein: the first indication is associated with the first subcarrier spacing; the method further comprises mapping the first indication to a second indication associated with the second subcarrier spacing; and identifying the uplink slot for the transmission of the SRS based on the second slot number and the first indication comprises identifying the uplink slot for the transmission of the SRS based on the second slot number and the second indication.

Aspect A213: The method of aspect A211 or A212, wherein the first frequency spectrum and the second frequency spectrum are allocated as paired spectrum for frequency division duplex communication.

Aspect A214: The method of any of aspects A211 through A213, wherein the first indication specifies an available slot relative to a reference slot.

Aspect A215: A user equipment (UE) comprising: a transceiver configured to communicate with a radio access network, a memory, and a processor communicatively coupled to the transceiver and the memory, wherein the processor and the memory are configured to perform any one of aspects A211 through A214.

Aspect A216: An apparatus configured for wireless communication comprising at least one means for performing any one of aspects A211 through A214.

Aspect A217: A non-transitory computer-readable medium storing computer-executable code, comprising code for causing an apparatus to perform any one of aspects A211 through A214.

Aspect A221: A method for wireless communication at a base station, the method comprising: generating a downlink control information (DCI) scheduling a transmission of a sounding reference signal (SRS), wherein the DCI comprises a bit field for an indication of a delay value for the transmission of the SRS; and transmitting the DCI via a first frequency spectrum associated with a first subcarrier spacing; wherein the DCI schedules the transmission of the SRS on a second frequency spectrum associated with a second subcarrier spacing that is different from the first subcarrier spacing.

Aspect A222: The method of aspect A221, further comprising: determining the delay value based on the first subcarrier spacing.

Aspect A223: The method of aspect A221 or A222, further comprising: determining the delay value based on the second subcarrier spacing.

Aspect A224: The method of any of aspects A221 through A223, wherein the indication specifies an available slot relative to a reference slot.

Aspect A225: A base station (BS) comprising: a transceiver, a memory, and a processor communicatively coupled to the transceiver and the memory, wherein the processor and the memory are configured to perform any one of aspects A221 through A224.

Aspect A226: An apparatus configured for wireless communication comprising at least one means for performing any one of aspects A221 through A224.

Aspect A227: A non-transitory computer-readable medium storing computer-executable code, comprising code for causing an apparatus to perform any one of aspects A221 through A224.

Aspect A231: A method for wireless communication at a user equipment, the method comprising: receiving a downlink control information (DCI) via a first component carrier associated with a first subcarrier spacing, wherein the DCI schedules a transmission of a sounding reference signal (SRS) on a second component carrier associated with a second subcarrier spacing that is different from the first subcarrier spacing; identifying a reference slot based on a slot of the DCI and a slot offset associated with the second subcarrier spacing; and identifying an uplink slot for the transmission of the SRS based on the reference slot and a first indication of a delay value for the transmission of the SRS.

Aspect A232: The method of aspect A231, wherein the slot offset is based on a time offset between the first component carrier and the second component carrier.

Aspect A233: A user equipment (UE) comprising: a transceiver configured to communicate with a radio access network, a memory, and a processor communicatively coupled to the transceiver and the memory, wherein the processor and the memory are configured to perform any one of aspects A231 through A232.

Aspect A234: An apparatus configured for wireless communication comprising at least one means for performing any one of aspects A231 through A232.

Aspect A235: A non-transitory computer-readable medium storing computer-executable code, comprising code for causing an apparatus to perform any one of aspects A231 through A232.

Aspect A237: A method for wireless communication at a base station, the method comprising: generating a downlink control information (DCI) scheduling a transmission of a sounding reference signal (SRS), wherein the DCI comprises a bit field for an indication of a delay value for the transmission of the SRS; and transmitting the DCI via a first component carrier associated with a first subcarrier spacing; wherein the DCI schedules the transmission of the SRS on a second component carrier associated with a second subcarrier spacing that is different from the first subcarrier spacing.

Aspect A238: The method of aspect A231, wherein a slot offset for the transmission of the SRS is based on a subcarrier spacing of the second component carrier.

Aspect A239: A base station (BS) comprising: a transceiver, a memory, and a processor communicatively coupled to the transceiver and the memory, wherein the processor and the memory are configured to perform any one of aspects A237 through A238.

Aspect A240: An apparatus configured for wireless communication comprising at least one means for performing any one of aspects A237 through A238.

Aspect A241: A non-transitory computer-readable medium storing computer-executable code, comprising code for causing an apparatus to perform any one of aspects A237 through A238.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may encompass a wide variety of actions. For example, “determining” may include calculating, computing, processing, deriving, investigating, looking up (e.g., looking up in a table, a database or another data structure), ascertaining, resolving, selecting, choosing, establishing, receiving (e.g., receiving information), accessing (e.g., accessing data in a memory), and the like.

One or more of the components, steps, features and/or functions illustrated in FIGS. 1-31 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in any of FIGS. 1, 2, 4, 5, 14, and 24 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment, comprising:
a transceiver;
a memory; and
a processor coupled to the transceiver and the memory, wherein the processor and the memory are configured to:
receive via the transceiver a plurality of indications specifying a plurality of time occasions relative to a reference slot for transmission of a sounding reference signal (SRS) by the user equipment, and
transmit via the transceiver the SRS at a time that is based on a first indication of the plurality of indications.

2. The user equipment of claim 1, wherein the plurality of indications comprises:
a first delay value; and
a second delay value.

3. The user equipment of claim 2, wherein:
the first delay value comprises a second indication to a first available slot; and
the second delay value comprises a third indication to a second available slot that is different from the first available slot.

4. The user equipment of claim 1, wherein the plurality of indications comprises:
a first delay value; and
an indication to use a first available slot.

5. The user equipment of claim 4, wherein the indication to use the first available slot comprises a value of zero.

6. The user equipment of claim 1, wherein:
the plurality of indications are for a specified SRS resource set; and
a time domain behavior of the specified SRS resource set is aperiodic.

7. The user equipment of claim 1, wherein the plurality of indications comprises:
at least one first delay value for a first SRS resource set of a plurality of SRS resource sets; and
at least one second delay value for a second SRS resource set of the plurality of SRS resource sets.

8. The user equipment of claim 1, wherein the processor and the memory are further configured to:
receive a radio resource control (RRC) configuration comprising a first field and a second field for the plurality of indications.

9. The user equipment of claim 1, wherein the processor and the memory are further configured to:
receive a downlink control information (DCI) comprising a bit field; and
select the first indication based on a value of the bit field.

10. The user equipment of claim 9, wherein:
the DCI comprises a DCI format 0_1, a DCI format 0_2, a DCI format 1_1, or a DCI format 1_2; and
the bit field is a single bit.

11. The user equipment of claim 9, wherein the plurality of indications map:
a first value of the bit field to a first delay value for the transmission of the SRS; and
a second value of the bit field to a second delay value for the transmission of the SRS.

12. The user equipment of claim 9, wherein the plurality of indications map:
a first value of the bit field to a first delay value for the transmission of the SRS; and
a second value of the bit field to an indication to use a first available slot for the transmission of the SRS.

13. The user equipment of claim 9, wherein: the bit field is dedicated for indicating which of a plurality of delay values is to be used for the transmission of the SRS, the bit field is reallocated for indicating which of the plurality of delay values is to be used for the transmission of the SRS, or an SRS request field is used to indicate the bit field.

14. The user equipment of claim 9, wherein the processor and the memory are further configured to:
receive a radio resource control (RRC) message specifying that the value of the bit field applies to all of a plurality of SRS resource sets defined for a bandwidth part.

15. The user equipment of claim 9, wherein the processor and the memory are further configured to:
receive a radio resource control (RRC) message specifying that the value of the bit field applies to a subset of a plurality of SRS resource sets defined for a bandwidth part.

16. The user equipment of claim 15, wherein the plurality of indications map:
a first value for the bit field to a first delay value for a first SRS resource set of the plurality of SRS resource sets;
the first value for the bit field to a second delay value for a second SRS resource set of the plurality of SRS resource sets;
a second value for the bit field to a third delay value for the first SRS resource set of the plurality of SRS resource sets; and
the second value for the bit field to a fourth delay value for the second SRS resource set of the plurality of SRS resource sets.

17. The user equipment of claim 9, wherein:
the DCI triggers the transmission of the SRS and does not schedule a data transmission; and
the bit field is a plurality of bits where each bit of the plurality of bits is mapped to a respective triggered SRS resource set.

18. The user equipment of claim 1, wherein the processor and the memory are further configured to:
receive downlink control information (DCI); and
responsive to determining that a bit field of the DCI for the plurality of indications is disabled, select a delay value of zero for transmitting the SRS, select a default delay value for transmitting the SRS, select a radio resource control (RRC) configured delay value for transmitting the SRS, or select a first available slot for transmitting the SRS.

19. The user equipment of claim 1, wherein:
the processor and the memory are further configured to receive a group common downlink control information (DCI);
the group common DCI includes a bit field for indicating at least one delay parameter for the transmission of the SRS; and
the processor and the memory are further configured to select the first indication based on a value of the bit field.

20. The user equipment of claim 19, wherein:
the group common DCI is a format 2_3 DCI; and
the group common DCI comprises a component carrier block that includes the bit field.

21. The user equipment of claim 19, wherein:
the group common DCI is a format 2_3 DCI;
the group common DCI comprises a payload that includes the bit field; and
the bit field comprises a plurality of bits that are mapped to a plurality of component carriers scheduled by the group common DCI.

22. The user equipment of claim 21, wherein the processor and the memory are further configured to receive a radio resource control (RRC) message comprising a pointer that maps:
a first bit of the bit field to at least a first component carrier of the plurality of component carriers; and
a second bit of the bit field to at least a second component carrier of the plurality of component carriers.

23. The user equipment of claim 19, wherein the processor and the memory are further configured to:
receive a radio resource control (RRC) message specifying that the bit field applies to all of a plurality of SRS resource sets defined for a bandwidth part.

24. The user equipment of claim 19, wherein the processor and the memory are further configured to:
receive a radio resource control (RRC) message specifying that the bit field applies to a subset of a plurality of SRS resource sets defined for a bandwidth part.

25. The user equipment of claim 1, wherein the processor and the memory are further configured to:
determine an available slot for the transmission of the SRS based on the first indication; and
transmit the SRS during the available slot.

26. The user equipment of claim 25, wherein the processor and the memory are further configured to: verify that a candidate slot indicated by the first indication is defined as an uplink slot, a special slot, or a flexible slot with sufficient time-domain and frequency-domain allocation for the transmission of the SRS, verify that the transmission of the SRS does not collide with a higher priority uplink signal or uplink channel scheduled during the candidate slot, verify that there is no change of an active bandwidth after a triggering DCI is received, verify that a slot format indicator was not received after the plurality of indications was received, or a combination thereof.

27. The user equipment of claim 1, wherein the processor and the memory are further configured to:
receive a downlink control information (DCI) via a first frequency spectrum associated with a first subcarrier spacing, wherein the DCI schedules the transmission of the SRS on a second frequency spectrum associated with a second subcarrier spacing that is different from the first subcarrier spacing;
map a first slot number of the DCI associated with the first subcarrier spacing to a second slot number associated with the second subcarrier spacing;
identify the reference slot based on the second slot number and a slot offset; and
identify an uplink slot for the transmission of the SRS based on the reference slot and the first indication.

28. The user equipment of claim 1, wherein the processor and the memory are further configured to:
receive a downlink control information (DCI) via a first component carrier associated with a first subcarrier spacing, wherein the DCI schedules the transmission of the SRS on a second component carrier associated with a second subcarrier spacing that is different from the first subcarrier spacing;
identify the reference slot based on a slot of the DCI and a slot offset associated with the second subcarrier spacing; and
identify an uplink slot for the transmission of the SRS based on the reference slot and the first indication.

29. The user equipment of claim 28, wherein the slot offset is based on a time offset between the first component carrier and the second component carrier.

30. A method for wireless communication at a user equipment, the method comprising:
receiving a plurality of indications specifying a plurality of time occasions relative to a reference slot for transmission of a sounding reference signal (SRS) by the user equipment; and
transmitting the SRS at a time that is based on a first indication of the plurality of indications.
